(19) United States
(12) Patent Application Publication
(10) Pub. No.: US 2025/0111744 A1
(43) Pub. Date: Apr. 3, 2025

(54) USER TRACKING SYSTEMS AND METHODS IN ELECTRONIC GAMING

(71) Applicant: Aristocrat Technologies, Inc., Las Vegas, NV (US)

(72) Inventors: Alfred Thomas, Las Vegas, NV (US); Joseph Kaminkow, Las Vegas, NV (US); Joseph Masinter, II, Las Vegas, NV (US); Scott Burns, Knoxville, TN (US); Jason Riggs, Austin, TX (US); Luka Brown, Austin, TX (US); Robert Butler, Austin, TX (US); Jehoshua Josue, Las Vegas, NV (US)

(21) Appl. No.: 18/791,946

(22) Filed: Aug. 1, 2024

Related U.S. Application Data
(60) Provisional application No. 63/586,888, filed on Sep. 29, 2023.

(51) Int. Cl. G07F 17/32; G06K 7/14

(52) U.S. Cl. CPC G07F 17/3239; G06K 7/1404

(57) ABSTRACT

An electronic gaming system is provided. The electronic gaming system may include an electronic gaming device including a scanner and a display device, at least one memory with instructions stored thereon, and at least one processor in communication with the at least one memory and the electronic gaming device, wherein the instructions, when executed by the at least one processor, may cause the at least one processor to (1) cause the scanner to read a player code displayed by a mobile device of a player; (2) identify a user identifier associated with the player based on the player code; (3) after identifying the user identifier, receive gameplay information from the electronic gaming device; and (4) store the received gameplay information in the at least one memory in association with the identified user identifier.

### CROSS-REFERENCE TO RELATED APPLICATIONS

This application claims the benefit of priority of U.S. Provisional Patent Application No. 63/586,888, filed Sep. 29, 2023, and entitled “USER TRACKING SYSTEMS AND METHODS IN ELECTRONIC GAMING,” the contents and disclosures of which are hereby incorporated in their entirety.

### TECHNICAL FIELD

The field of disclosure relates generally to electronic gaming, and more specifically, network-based user tracking systems and methods for tracking users of electronic games in a quasi-anonymous manner.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a player tracking system is provided. The electronic gaming system may include an electronic gaming device including a scanner and a display device, at least one memory with instructions stored thereon, and at least one processor in communication with the at least one memory and the electronic gaming device, wherein the instructions, when executed by the at least one processor, may cause the at least one processor to: (1) cause the scanner to read a player code displayed by a mobile device of a player, the mobile device executing a mobile application; (2) receive gameplay information from the electronic gaming device; (3) determine whether the read player code is associated with an existing user identifier corresponding to a user account stored in the at least one memory; (4) if the player code is associated with an existing user identifier, store the received gameplay information in the at least one memory in association with the existing user identifier; and (5) if the player code is not associated with an existing user identifier, store the received gameplay information in the at least one memory in association with the read player code.

In another aspect, a method for user tracking in electronic gaming is provided. The method may be performed by at least one processor in communication with the at least one memory and an electronic gaming device including a scanner and a display device. The method may include: (1) causing the scanner to read a player code displayed by a mobile device of a player, the mobile device executing a mobile application; (2) receiving gameplay information from the electronic gaming device; (3) determining whether the read player code is associated with an existing user identifier corresponding to a user account stored in the at least one memory; (4) if the player code is associated with an existing user identifier, storing the received gameplay information in the at least one memory in association with the existing user identifier; and (5) if the player code is not associated with an existing user identifier, storing the received gameplay information in the at least one memory in association with the read player code.

In another aspect, at least one non-transitory computer-readable storage media having instructions embodied thereon is provided. When executed by at least one processor in communication with the at least one memory and an electronic gaming device including a scanner and a display device, the instructions may cause the at least one processor to: (1) cause the scanner to read a player code displayed by a mobile device of a player, the mobile device executing a mobile application; (2) receive gameplay information from the electronic gaming device; (30 determine whether the read player code is associated with an existing user identifier corresponding to a user account stored in the at least one memory; (4) if the player code is associated with an existing user identifier, store the received gameplay information in the at least one memory in association with the existing user identifier; and (5) if the player code is not associated with an existing user identifier, store the received gameplay information in the at least one memory in association with the read player code.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates a gaming system according to an exemplary embodiment of the present disclosure.

FIG. 5 illustrates an electronic gaming machine including a display according to an exemplary embodiment of the present disclosure.

FIG. 6A illustrates a message display according to an exemplary embodiment of the present disclosure.

FIG. 6B illustrates another message display according to an exemplary embodiment of the present disclosure.

FIG. 7 illustrates a mobile application user interface according to an exemplary embodiment of the present disclosure.

FIG. 8A illustrates another mobile application user interface according to an exemplary embodiment of the present disclosure.

FIG. 8B illustrates another mobile application user interface according to an exemplary embodiment of the present disclosure.

FIG. 9A illustrates a display overlay for an electronic gaming device according to an exemplary embodiment of the present disclosure.

FIG. 9B illustrates another display overlay for an electronic gaming device according to an exemplary embodiment of the present disclosure.

FIG. 10A illustrates another display overlay for an electronic gaming device according to an exemplary embodiment of the present disclosure.

FIG. 10B illustrates another display overlay for an electronic gaming device according to an exemplary embodiment of the present disclosure.

FIG. 11A illustrates another display overlay for an electronic gaming device according to an exemplary embodiment of the present disclosure.

FIG. 11B illustrates another display overlay for an electronic gaming device according to an exemplary embodiment of the present disclosure.

FIG. 12 illustrates exemplary award badges that may be earned by a user according to an exemplary embodiment of the present disclosure.

FIG. 13A illustrates another mobile application user interface according to an exemplary embodiment of the present disclosure.

FIG. 13B illustrates another mobile application user interface according to an exemplary embodiment of the present disclosure.

FIG. 14A illustrates another display overlay for an electronic gaming device according to an exemplary embodiment of the present disclosure.

FIG. 14B illustrates another display overlay for an electronic gaming device according to an exemplary embodiment of the present disclosure.

FIG. 15A illustrates another mobile application user interface according to an exemplary embodiment of the present disclosure.

FIG. 15B illustrates another mobile application user interface according to an exemplary embodiment of the present disclosure.

FIG. 16A illustrates another display overlay for an electronic gaming device according to an exemplary embodiment of the present disclosure.

FIG. 16B illustrates another display overlay for an electronic gaming device according to an exemplary embodiment of the present disclosure.

FIG. 17A illustrates another mobile application user interface according to an exemplary embodiment of the present disclosure.

FIG. 17B illustrates another mobile application user interface according to an exemplary embodiment of the present disclosure.

FIG. 18A illustrates another display overlay for an electronic gaming device according to an exemplary embodiment of the present disclosure.

FIG. 18B illustrates another display overlay for an electronic gaming device according to an exemplary embodiment of the present disclosure.

FIG. 19A illustrates another mobile application user interface according to an exemplary embodiment of the present disclosure.

FIG. 19B illustrates another mobile application user interface according to an exemplary embodiment of the present disclosure.

FIG. 20 illustrates another display overlay for an electronic gaming device according to an exemplary embodiment of the present disclosure.

FIG. 21A illustrates another mobile application user interface according to an exemplary embodiment of the present disclosure.

FIG. 21B illustrates another mobile application user interface according to an exemplary embodiment of the present disclosure.

FIG. 21C illustrates another mobile application user interface according to an exemplary embodiment of the present disclosure.

FIG. 22A illustrates another mobile application user interface according to an exemplary embodiment of the present disclosure.

FIG. 22B illustrates another mobile application user interface according to an exemplary embodiment of the present disclosure.

FIG. 23 illustrates another mobile application user interface according to an exemplary embodiment of the present disclosure.

FIG. 24 illustrates a leaderboard display according to an exemplary embodiment of the present disclosure.

FIG. 25A illustrates a portion of an electric gaming device including a quick response (QR) scanner and an instructional sticker according to an exemplary embodiment of the present disclosure.

FIG. 25B illustrates the instructional sticker shown in FIG. 25A.

FIG. 26 illustrates another mobile application user interface according to an exemplary embodiment of the present disclosure.

FIG. 27 illustrates another mobile application user interface according to an exemplary embodiment of the present disclosure.

FIG. 28 illustrates another mobile application user interface according to an exemplary embodiment of the present disclosure.

FIG. 29 is a flow diagram illustrating an exemplary process for connecting a mobile device to an electronic gaming machine according to an exemplary embodiment of the present disclosure.

FIG. 30 is a flow diagram illustrating an exemplary process for performing a game instance, or “spin,” on an electronic gaming machine connected to a mobile device according to an exemplary embodiment of the present disclosure.

FIG. 31 is a flow diagram illustrating an exemplary process for controlling an electronic gaming machine according to an exemplary embodiment of the present disclosure.

FIG. 32 is a flow diagram illustrating an exemplary process for controlling a mobile application according to an exemplary embodiment of the present disclosure.

FIG. 33 is a flow diagram illustrating an exemplary process for enrolling a user using a mobile application according to an exemplary embodiment of the present disclosure.

FIG. 34 is a table illustrating exemplary conditions under which a badge may be earned by a player according to an exemplary embodiment of the present disclosure.

FIG. 35 is a table illustrating exemplary conditions under which a badge may be earned by a player according to an exemplary embodiment of the present disclosure.

FIG. 36 is a system diagram illustrating an exemplary gaming system according to an exemplary embodiment of the present disclosure.

FIG. 37 illustrates a process for creating a user account using a mobile application according to an exemplary embodiment of the present disclosure.

FIG. 38 illustrates a process for connecting a mobile device to an electronic gaming device according to an exemplary embodiment of the present disclosure.

FIG. 39 is a system diagram illustrating an exemplary gaming system according to an exemplary embodiment of the present disclosure.

FIG. 40 is a diagram illustrating an exemplary message according to an exemplary embodiment of the present disclosure.

FIG. 41 is a diagram illustrating an exemplary message according to an exemplary embodiment of the present disclosure.

### DETAILED DESCRIPTION

Described herein is a user tracking system for tracking users/players of electronic games in a quasi-anonymous manner. It is desirable for players and electronic game operators to track player activity. For example, players may find it enjoyable to track gaming achievements and/or have their name shown on a leaderboard based on these achievements. However, players may be reluctant to provide personally identifiable information to an electronic gaming operator for the purposes of player tracking. Additionally, it may be useful to track activity of players who do not have player accounts, so that if the player desires to set up a player tracking account in the future, previous player activity can be linked to the account. Therefore, a problem exists in how to track in-game activity for players quasi-anonymously, while maintaining the ability for on-demand sign up and linking of other (e.g., non-anonymous) player accounts (e.g., casino loyalty accounts).

Compared to known player tracking systems, such as those utilizing player loyalty accounts, the system described herein uses limited information that may be used to identify a player in a quasi-anonymous fashion (e.g., quick response (QR) code and, in some cases, an associated user name) but does not include personally identifiable information (PII) that may be considered confidential to track players, and therefore only requires this limited, quasi-anonymous information to be provided by players. For example, players may only be required to download an associated mobile application (“app”) and select a username in order to be tracked by the system. Thus, the present system is configured to quickly enroll a player in the system, track the player's game play, and provide a certain level of data security because the system does not require the player to provide any PII information but is still able to track the player's game play.

The system may include a server and one or more electronic gaming machines (EGMs) and/or one or more gaming devices. The EGMs (also includes gaming devices such as tablets or mobile devices) may include a QR scanner or other type of device capable of recognizing a unique player code associated with the player or the player's mobile device (e.g., a barcode, facial, or other type of optical scanner, and/or a Bluetooth and/or near field communication (NFC) scanner). The player may scan a QR code displayed by the player's mobile device using the QR scanner of the EGM, which causes the system to recognize that the player is present at the EGM.

If the system determines the QR code corresponds to an existing player account, gameplay information may be collected during the subsequent gameplay session and stored in association with the player account. If the QR code does not correspond to an existing player account, the system may cause the player's mobile device to prompt the user to input player information for creating a new account. If the player opts to create an account and inputs player information, a player account may be created and gameplay information may be collected during the subsequent gameplay session and stored in association with the new player account.

If the player code is not associated with a player account and the opts not to create an account, gameplay information may be collected during the subsequent gameplay session and stored in association with the player code itself. Thus, if the player chooses to create an account at a later time, this saved gameplay information may be associated with the subsequently created account, enabling the player to build off of tracked activity that occurred prior to creation of the player account.

In some embodiments, the EGM may display a username or other information associated with the player while the player is connected to the EGM. As the player engages in gameplay at the EGM, certain gameplay information may be provided by the EGM to the server. The server may compare this information to predefined rules (defined by a machine operator or casino operator and stored in a rules engine) to determine if the player has met conditions to be awarded a badge, achievement, and/or other virtual or tangible awards, as described in further detail below. When a badge or achievement is earned, the server may transmit information to the mobile device and/or EGM causing the mobile device and/or EGM to display a message the earned badge or achievement. Further, the player may access an app or web page that enables to the player to view a collection of previously-earned badges or achievements.

In some embodiments, the system may further include a leaderboard, which may be positioned (e.g., in a casino) near one or more EGMs that are connected to the server. The server may determine, based on gameplay information, players to display on the leaderboard (e.g., those who have a certain game the most and/or won the most paying that game). The server may instruct the leaderboard to display information associated with these players, such as a username and/or avatar. The server may further cause the mobile device associated with a player and/or an EGM at which the player is present to display a message indicating that the player has earned a position on the leaderboard or moved up to a higher position on the leaderboard.

In some embodiments, data collected by the system may be linked to player loyalty accounts, including player loyalty accounts that may have been created subsequently to registering with the system. A quasi-anonymous set of data may be shared and used to drive a loyalty program including awarding badges, achievements/milestones, display competitive achievements and leaderboards across same game types or across multiple different game types, and send specific users promotional notification and opportunities based on past game play. The capability can be local or functionality can be used across multiple different gaming locations and jurisdictions. Because different jurisdictions may have different rules associated with player loyalty accounts and personally identifiable information (PII), player information could move across jurisdictions with different PII laws, and thus, an anonymous set of data could be shared and transported across state lines and linked accordingly with respective accounts. Thus, the current system allows players to select whether to maintain their game play data as being quasi-anonymous, or whether to link the quasi-anonymous game play data to a player account that includes identifiable information.

Accordingly, the electronic gaming device described herein may provide at least the following technical benefits: (a) an ability to quasi-anonymously track player activity using a code scannable by a gaming device and storing the player activity in association with the scannable code; (b) an ability to link previous player activity to a newly created player account or player account not previously tied to the player activity by providing a user interface through which a player may link a player account to a scannable code used to track the previous player data; and (c) an ability to cause a gaming device or leaderboard to display personalized information relating to a player using a scanner that detects a player code, performing a lookup to retrieve data stored in association with the player code, and displaying at least some of the retrieved data on the gaming device or leaderboard.

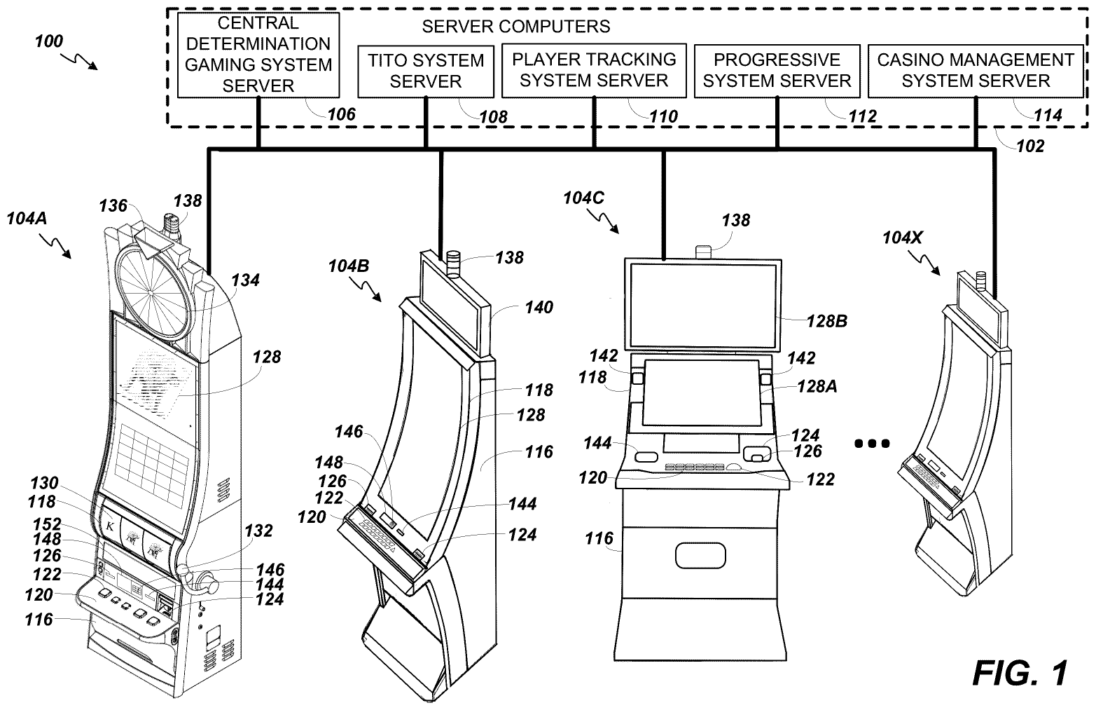

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

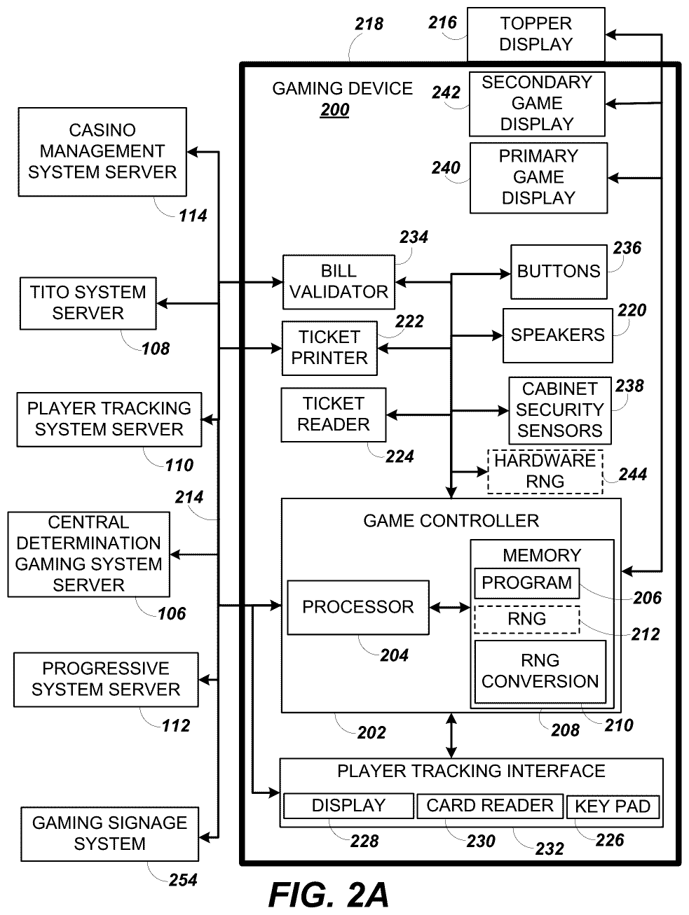

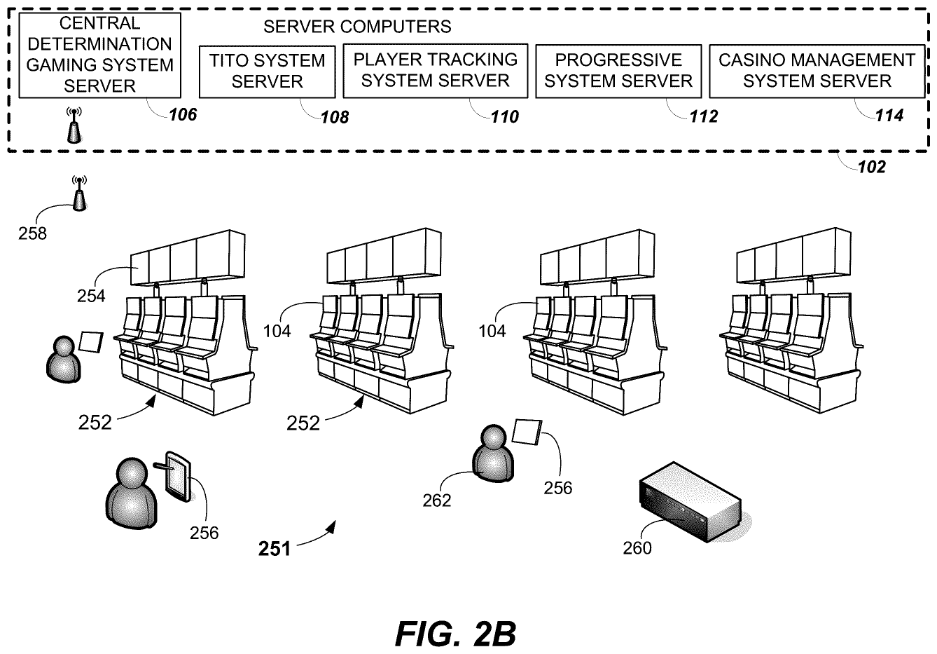

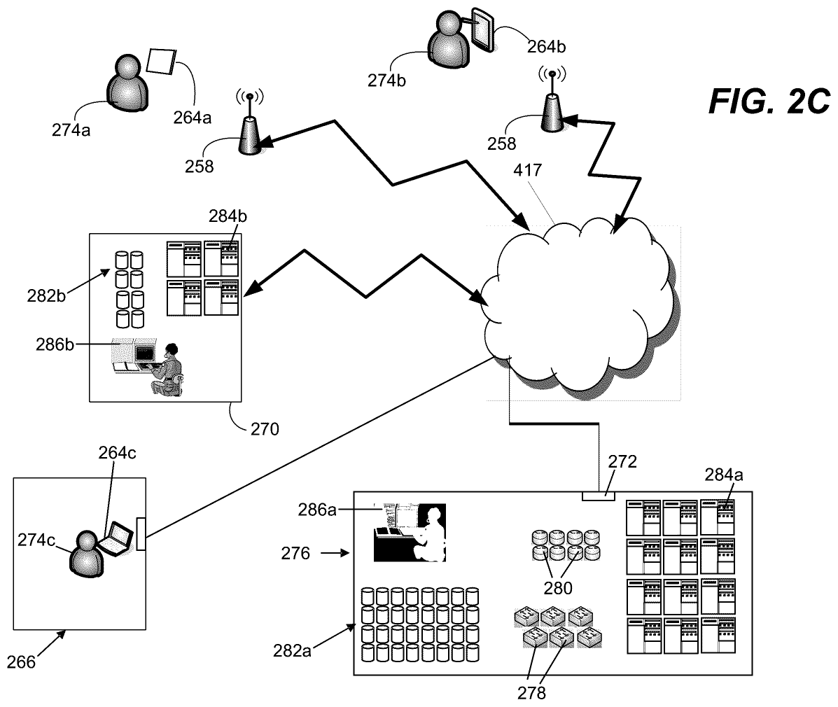

Many or all of the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

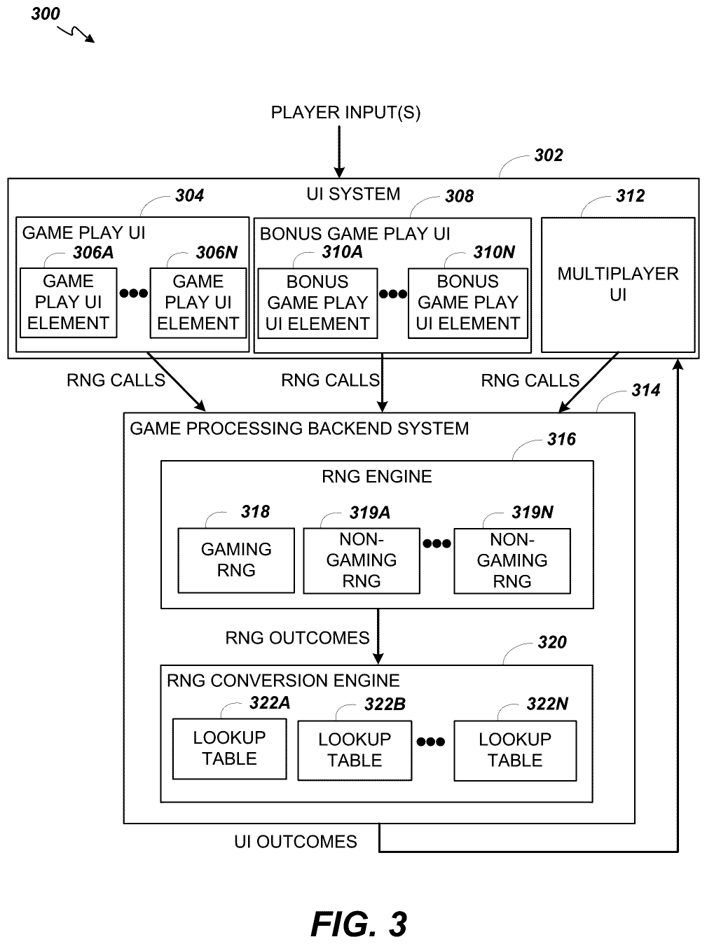

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

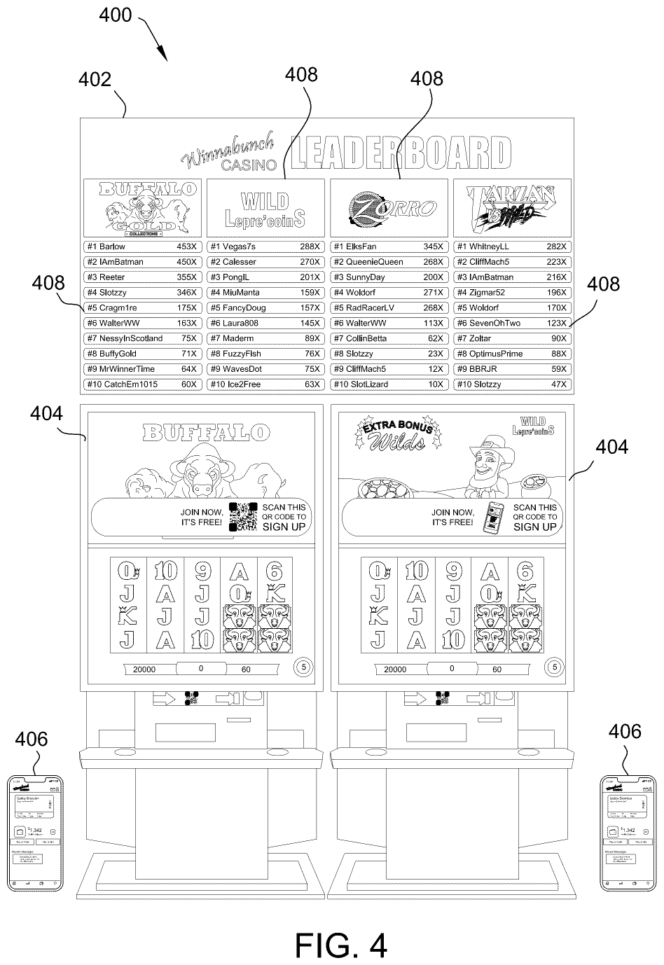

FIG. 4 illustrates an exemplary gaming system 400 including a leaderboard 402, EGMs 404, which may be similar to gaming devices 104A-104X (shown in FIG. 1), and mobile devices 406, which may be similar to EUDs 264 (shown in FIG. 2). Each EGM 404 has a sticker and QR Code Reader, which as described in further detail below, may scan a QR code or other code displayed by mobile devices 406. Different players, one on each game, can connect simultaneously to respective EGMS 404 using their corresponding mobile devices 406. As shown in FIG. 4, each EGM 404 may be configured for a different game, and leaderboard 402 includes a plurality of columns 408 associated with different games that may be displayed by different EGMS 404.

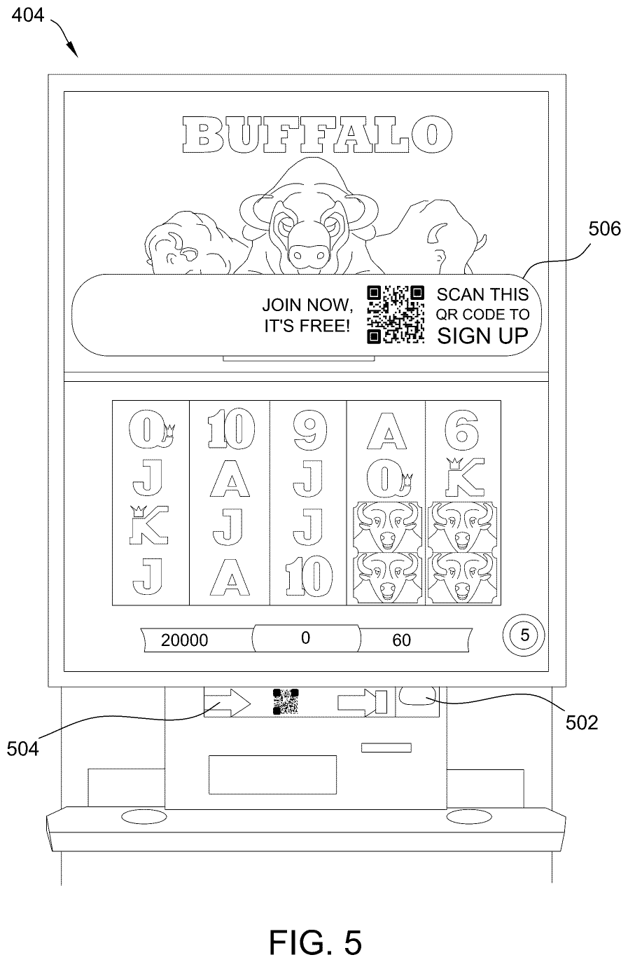

FIG. 5 illustrates an exemplary EGM 404 illustrating one game theme of a plurality of potential game themes. Below the main video display and above a player tracking unit is a QR scanner 502 and a sign 504 (e.g., a sticker) with instructions prompting the player to create an account and use their QR code to log in. A message display 506 at the bottom of the top screen provides information about how to connect, such as a QR code that may be scanned using mobile devices 406 to cause mobile devices 406 to display and/or download an associated app and/or other information.

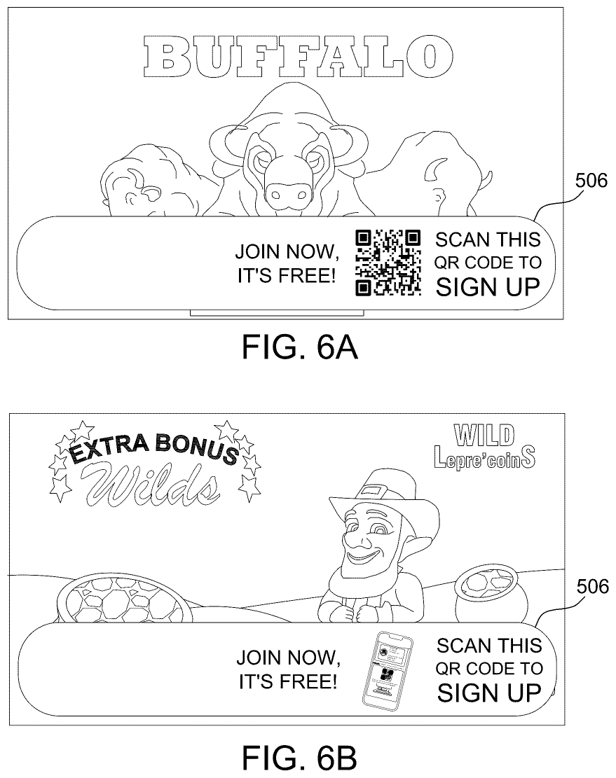

FIGS. 6A and 6B illustrate message display 506 in more detail. In some embodiments, message display 506 may alternate or change (e.g., every 30 seconds) between showing a QR code as shown in FIG. 6A and instructions as shown in FIG. 6B.

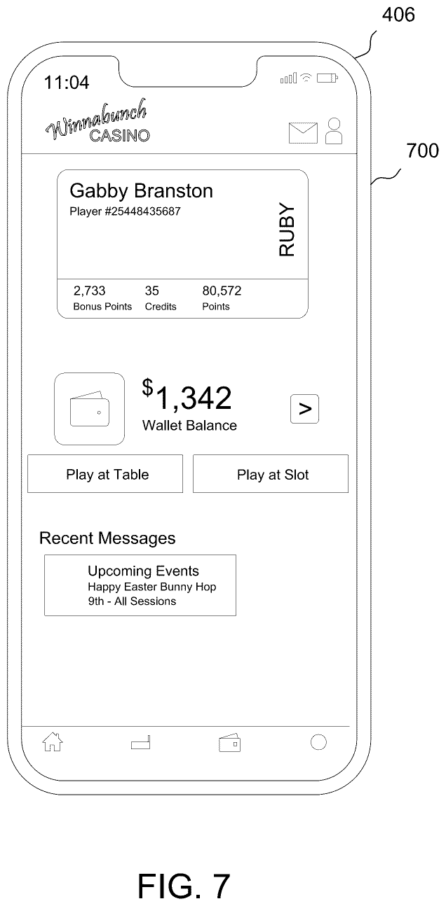

FIG. 7 illustrates an exemplary app 700 that may be displayed by mobile device 406. When app 700 is opened by a player, it will connect to a server to log the player in. In some embodiments, different screens within app 700 may be implemented as web pages hosted by the server, while other aspects of app 700 (e.g., menus and/or selection tiles) may be executed locally by mobile device 406.

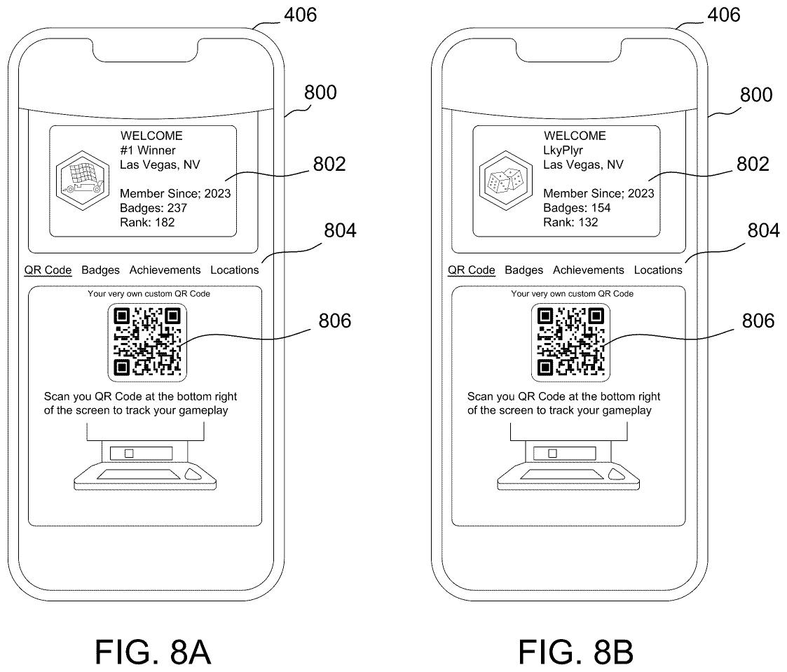

FIGS. 8A and 8B illustrate exemplary pages 800 of app 700 for different respective example players (with usernames “#1 Winner” and “LkyPlyr”). Pages 800 may include a header 802, which may include the player's avatar, the player's gamer tag, the player's location, how long the player has been a member, achievements earned by the player, player rank, and/or other such information. Pages 800 further include a navigation bar 804, which includes links to navigate to a news page, a badges page, an achievements page, a locations page (each described in further detail below), and/or other pages. Page 800 further includes a QR code 806, which may be used by a player to connect to an EGM 404 as described in further detail below.

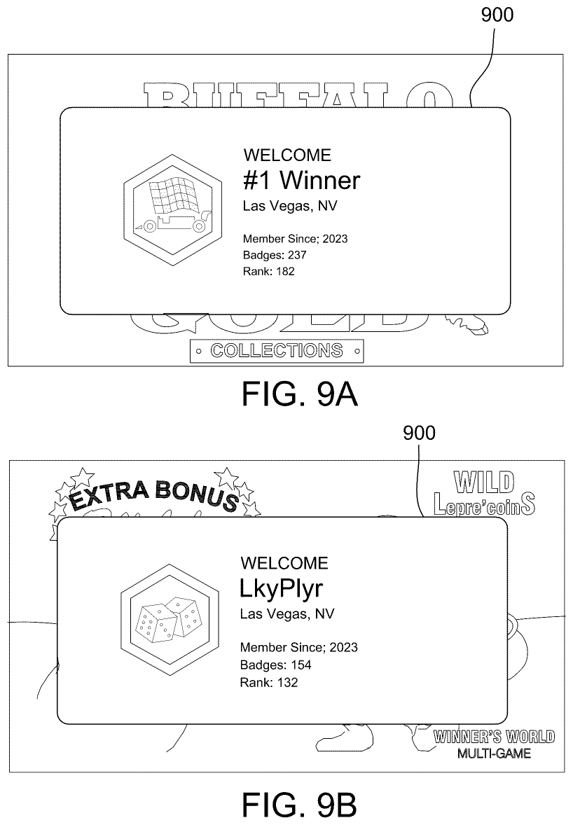

FIGS. 9A and 9B illustrate exemplary display overlays 900 which may be displayed by EGMs 404 in response to respective players (with usernames “#1 Winner” and “LkyPlyr”) connecting to EGMs 404 using their respective mobile devices 406, for example, by scanning QR code 806 with QR scanner 502. In some embodiments, display overlays 900 may be displayed over a pre-existing game display of EGMs 404. After connecting, EGMs 404 may communicate to the server that the player has connected to that specific EGM 404. The server may communicate to the EGM 404 information associated with the player (e.g., the player name, place of residence, member since, achievements, and/or rank), which may be displayed within displays 900. For example, as shown in FIG. 9A, display overlay 900 may include the following information when user “#1 Winner”: Player: #1 Winner; Avatar: Racecar; Location: Las Vegas, NV; Member Since: 2023; Achievements: 237; and Rank: 182. As shown in FIG. 9B, display overlay 900 may include the following information when user “LkyPlyr”: Player: LkyPlyr; Avatar: Dice; Location: Las Vegas, NV; Member Since: 2023; Achievements: 154; and Rank: 132.

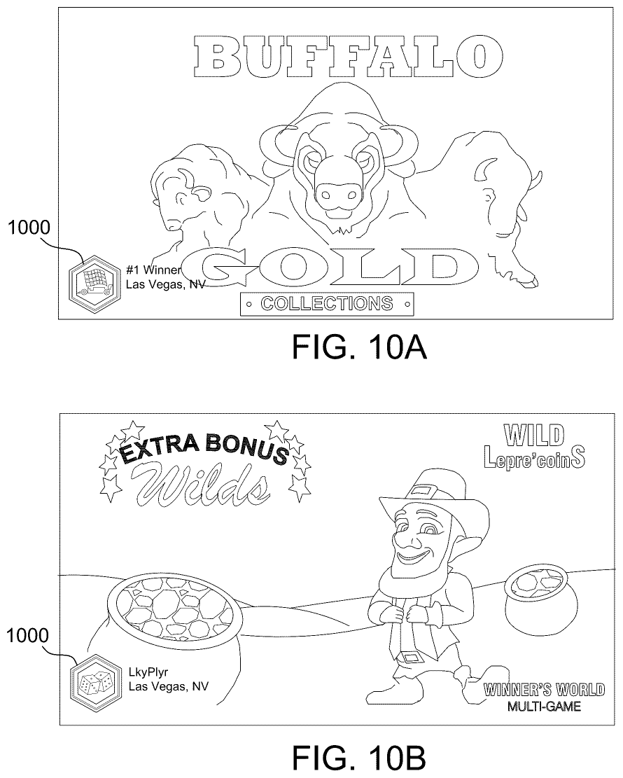

FIGS. 10A and 10B illustrate exemplary display overlays 1000 which may be displayed by EGMs 404. In some embodiments, display overlays 1000 may be displayed over a pre-existing game display of EGMs 404. Display overlays 1000 may be displayed after a predefined period (e.g., about three seconds) after display overlays 900 are displayed. In other words, display overlays 900 may transition and/or fade into display overlays 1000 after the predefined period. Display overlays 1000 may include information such as the player's avatar, name, and location shown, for example, in the bottom left-hand corner. The information shown in display overlays 1000 may be smaller or lower profile relative to that shown in display overlays 900, such that more of the pre-existing game display of EGMs 404 is visible.

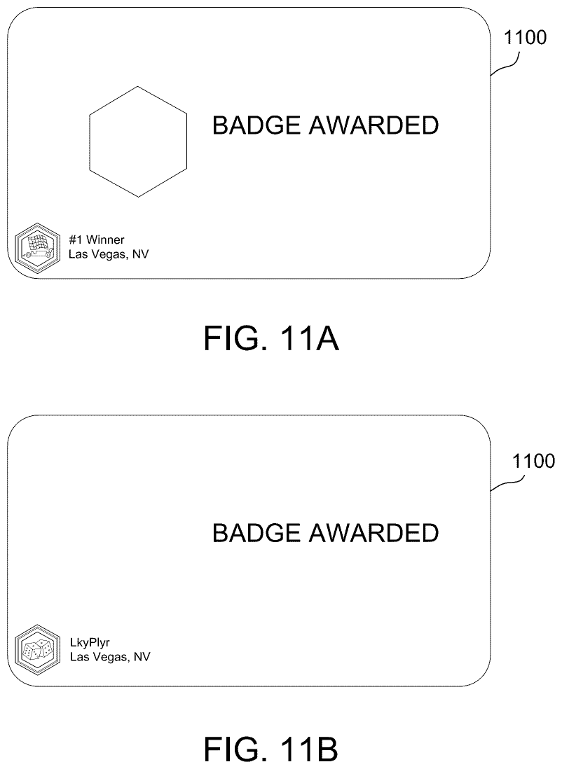

FIGS. 11A and 11B illustrate exemplary display overlays 1100 which may be displayed by EGMs 404. In some embodiments, display overlays 1100 may be displayed over a pre-existing game display of EGMs 404. EGM 404 may show display overlays 1100 in response to the player being awarded a badge 1102. Badges 1102 may be awarded based on player-controlled actions, such as an amount of time playing, a number of times played, and/or playing at a specific time and/or during a specific event. Display overlay 1100 may include (1) an image of the badge 1102, (2) t “badge awarded” header, (3) a name of the badge 1102, and/or (4) a short description of how the badge 1102 was earned. Display overlay 1100 may disappear (e.g., by transitioning to display overlays 1000) after a predefined period of time and/or when the player initiates further gameplay (e.g., by pressing a spin button of EGM 404).

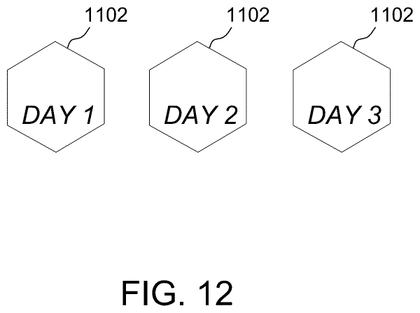

FIG. 12 illustrates three exemplary badges 1102.

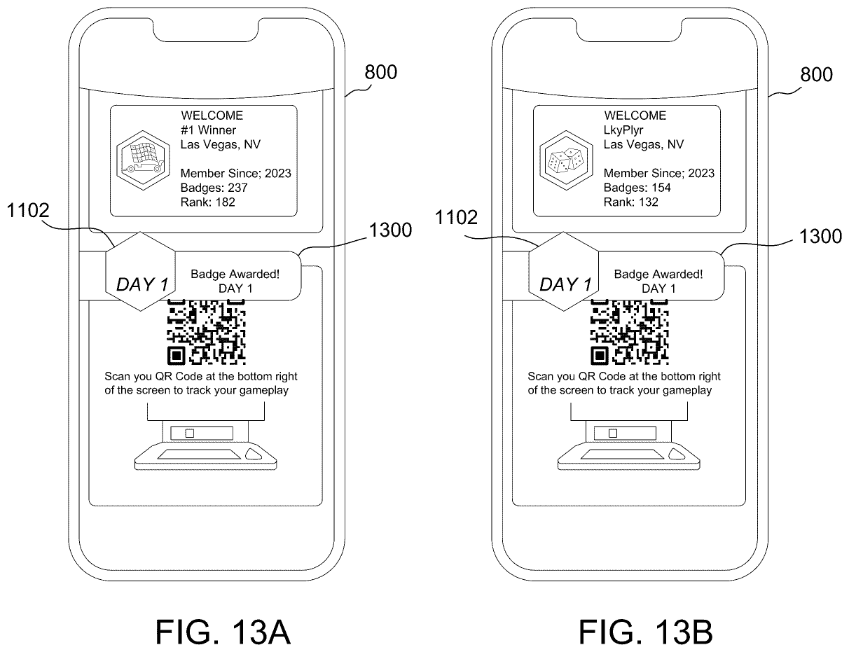

FIGS. 13A and 13B illustrate a message 1300 that may be displayed on page 800 of app 700 in response to a badge 1102 being awarded. The message may include the badge 1102 and associated information.

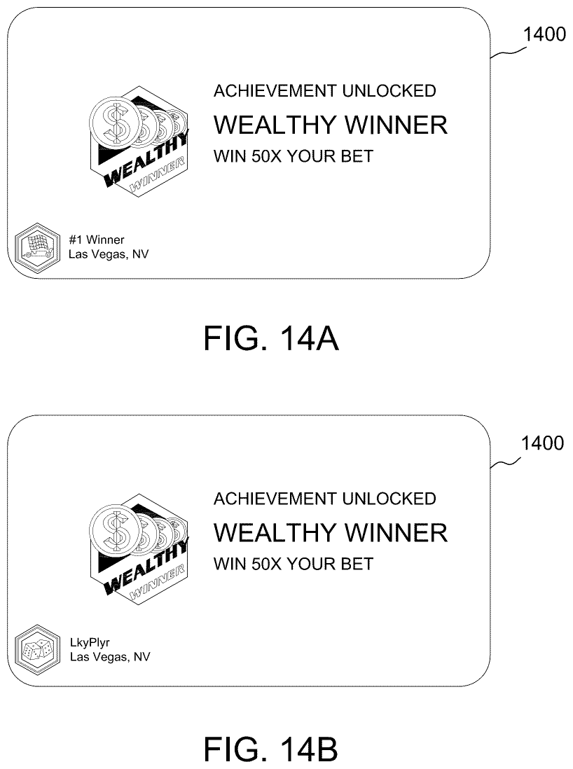

FIGS. 14A and 14B illustrate exemplary display overlays 1400 which may be displayed by EGMs 404. In some embodiments, display overlays 1400 may be displayed over a pre-existing game display of EGMs 404. EGM 404 may show display overlays 1400 in response to the player being awarded an achievement 1402. Achievements 1402 may be awarded based on game outcomes, such as by winning a certain multiple of the player's bet (e.g., as shown in FIGS. 14A and 14B). Display overlay 1400 may disappear (e.g., by transitioning to display overlays 1000) after a predefined period of time and/or when the player initiates further gameplay (e.g., by pressing a spin button of EGM 404).

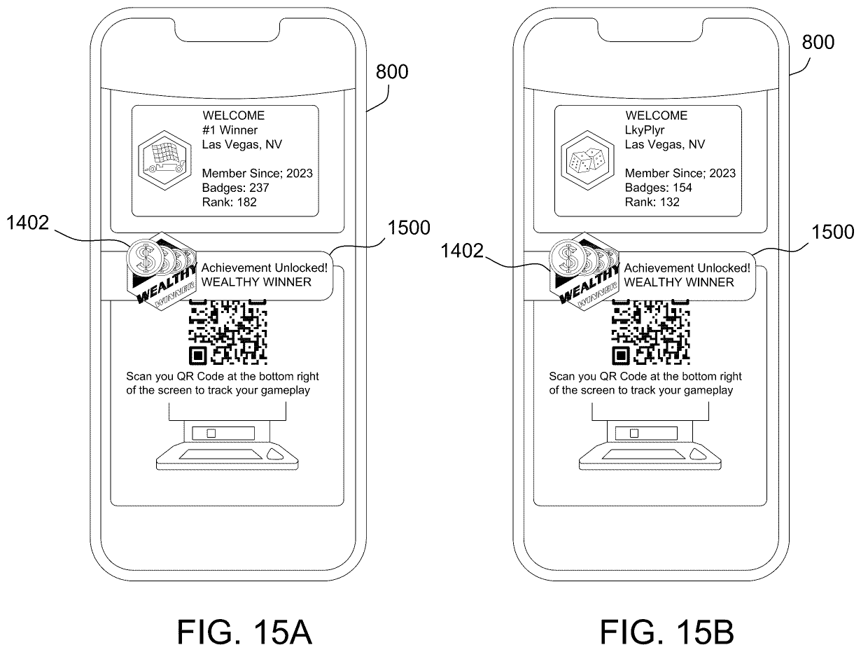

FIGS. 15A and 15B illustrate a message 1500 that may be displayed on page 800 of app 700 in response to an achievement 1402 being awarded. In some embodiments, message 1500 may include (1) an image of the achievement 1402 icon, (2) an “achievement unlocked” header, and (3) a name of the achievement 1402.

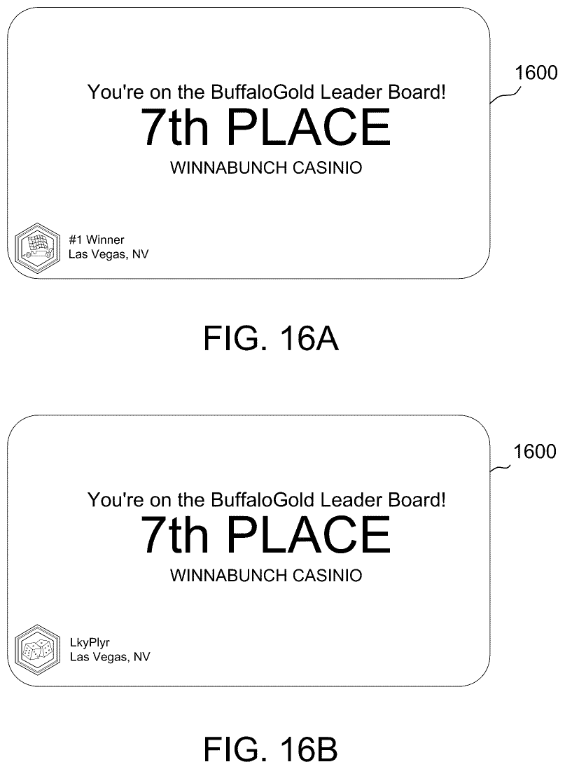

FIGS. 16A and 16B illustrate exemplary display overlays 1600 which may be displayed by EGMs 404. In some embodiments, display overlays 1600 may be displayed over a pre-existing game display of EGMs 404. EGM 404 may show display overlays 1600 in response to the player earning a spot on leaderboard 402 (shown in FIG. 4) via by achieving certain gameplay outcomes. For example, FIGS. 16A and 16B illustrate a display overlays 1600 that may be displayed in response to a win around 100× that, in this example, gets the player on the leaderboard in seventh (e.g., there may be only six players who received a greater win).

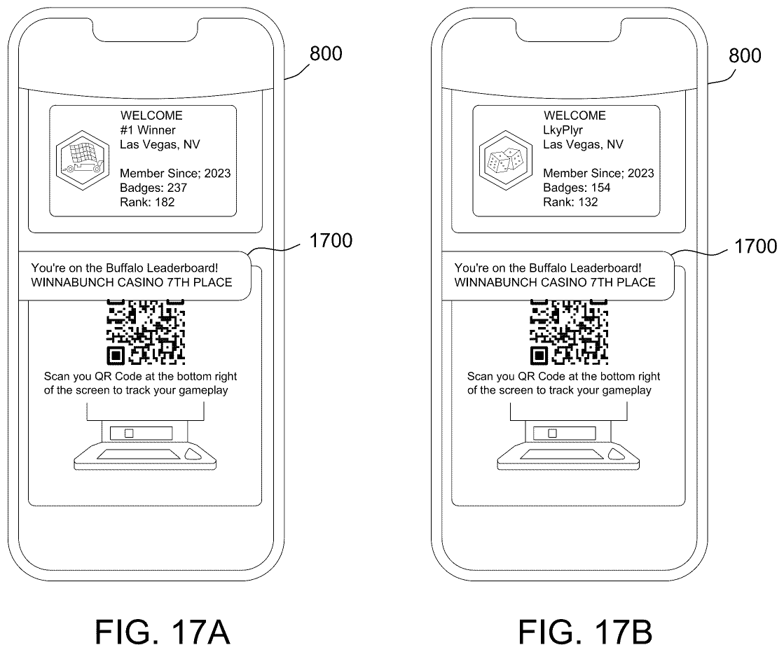

FIGS. 17A and 17B illustrate a message 1700 that may be displayed on page 800 of app 700 in response to the player getting onto the leaderboard. Message 1700 may indicate that the player has earned a place on the leaderboard and which place the player has earned.

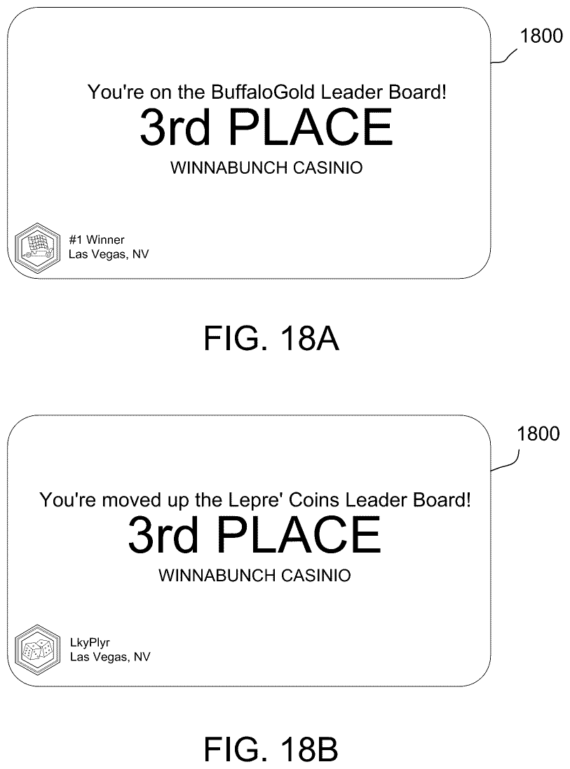

FIGS. 18A and 18B illustrate exemplary display overlays 1800 which may be displayed by EGMs 404. In some embodiments, display overlays 1800 may be displayed over a pre-existing game display of EGMs 404. EGM 404 may show display overlays 1800 in response to a player, having already earned a spot on leaderboard 402, moving up in ranking on the leaderboard. For example, FIGS. 18A and 18B illustrate a display overlays 1800 that may be displayed in response to a higher win multiplier and moving up the leaderboard to third place (e.g., the player in seventh place surpassed those previously in third through sixth place).

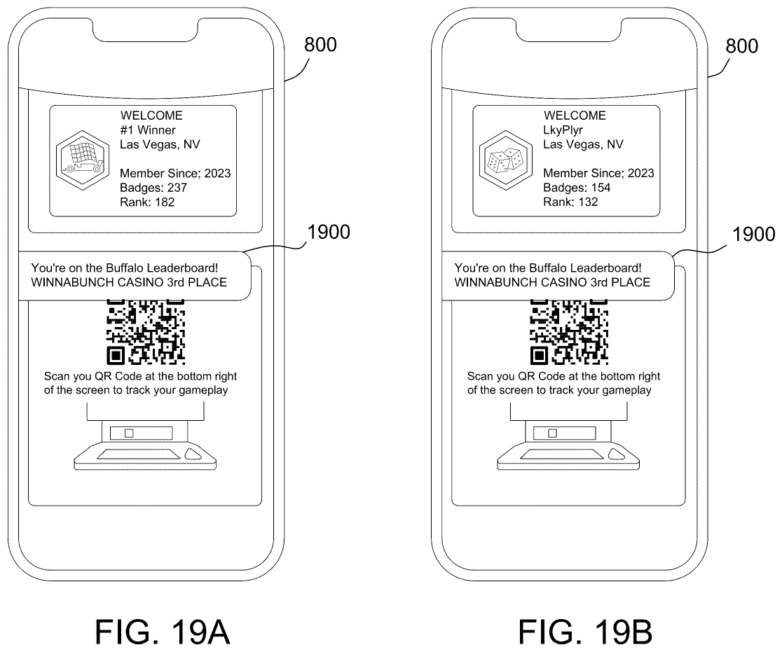

FIGS. 19A and 19B illustrate a message 1900 that may be displayed on page 800 of app 700 in response to the player moving up on the leaderboard.

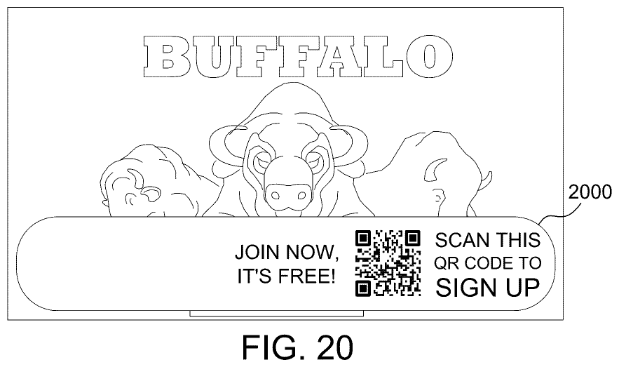

FIG. 20 illustrates a message 2000, similar to message display 506, which may be displayed after the connected player cashes out of EGM 404, thereby setting EGM 404 up for another player. Leaderboard 402 and app 700 may continue to show the player's info after the player cashes out of EGM 404.

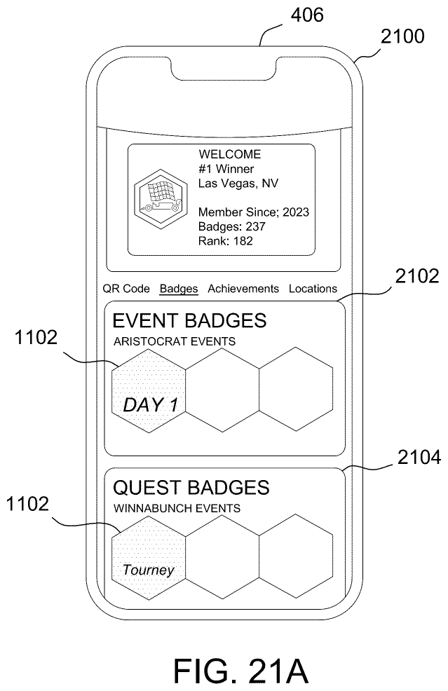

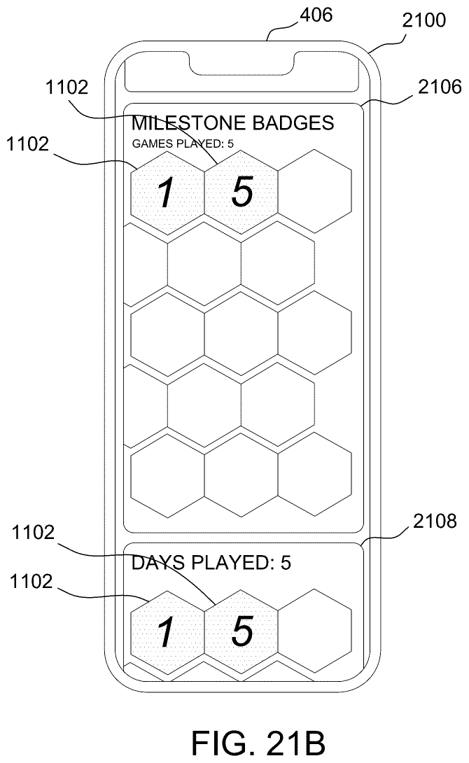

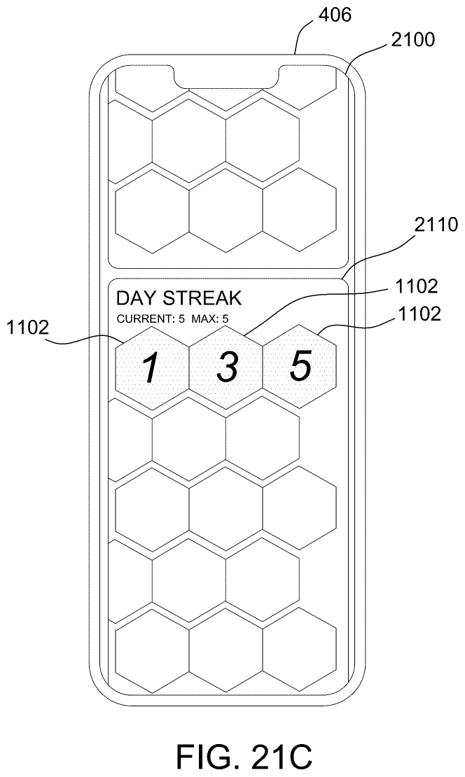

FIGS. 21A, 21B, and 21C illustrate a page 2100 of app 700 that may show badges 1102 that have been earned by a player (e.g., “#1 Winner”), for example, in response to the player selecting “Badges” on navigation bar 804 (shown in FIG. 8). These badges 1102 may include event badges 2102 (e.g., earned by attending certain events), quest badges 2104, milestone badges 2106 (e.g., earned based on a number of games played), days played badges 2108 (e.g., earned based on a total number of days played), days streak badges 2110 (e.g., earned based on a number of consecutive days played), and/or other types of badges 1102.

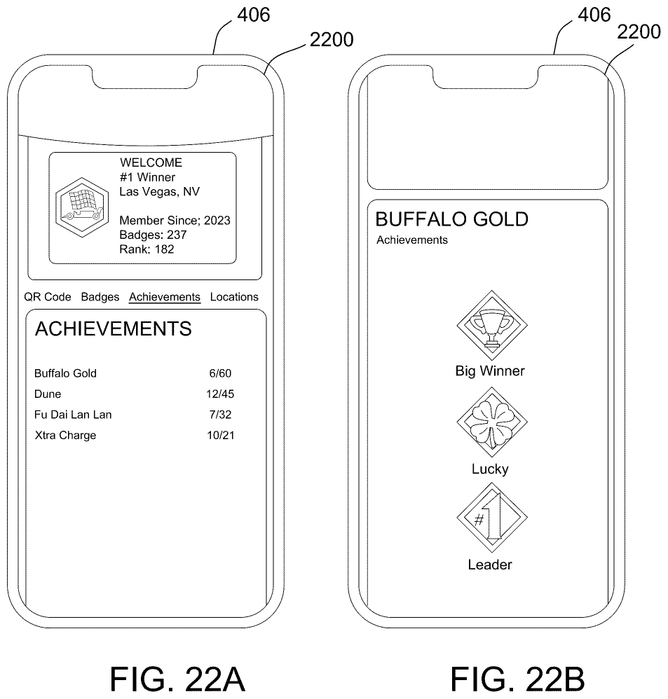

FIGS. 22A and 22B illustrate a page 2200 of app 700 that may show achievements 1402 that have been earned by a player (e.g., “#1 Winner”). When the player selects “Achievements” on navigation bar 804 (shown in FIG. 8), a list of games and the number of achievements 1402 earned for each game appears. After selecting one of the games, app 700 may display the name of the of the game at the top along with the number of achievements, as shown in FIGS. 22A and 22B. Below that will be the achievements 1402 earned, for example, in alphabetical order.

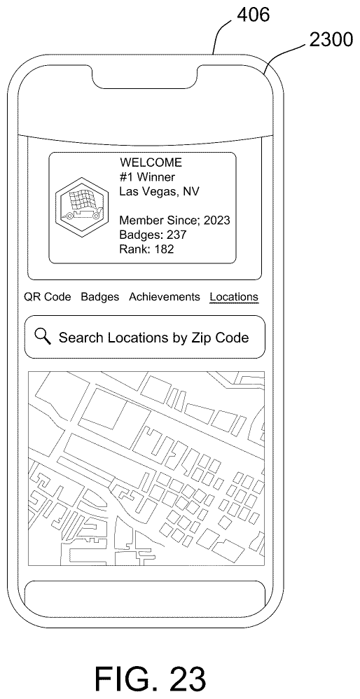

FIG. 23 illustrate a page 2300 of app 700 that may show a player's location within a casino or other property. Page 2300 may be displayed in response to the player selecting “Locations” on navigation bar 804.

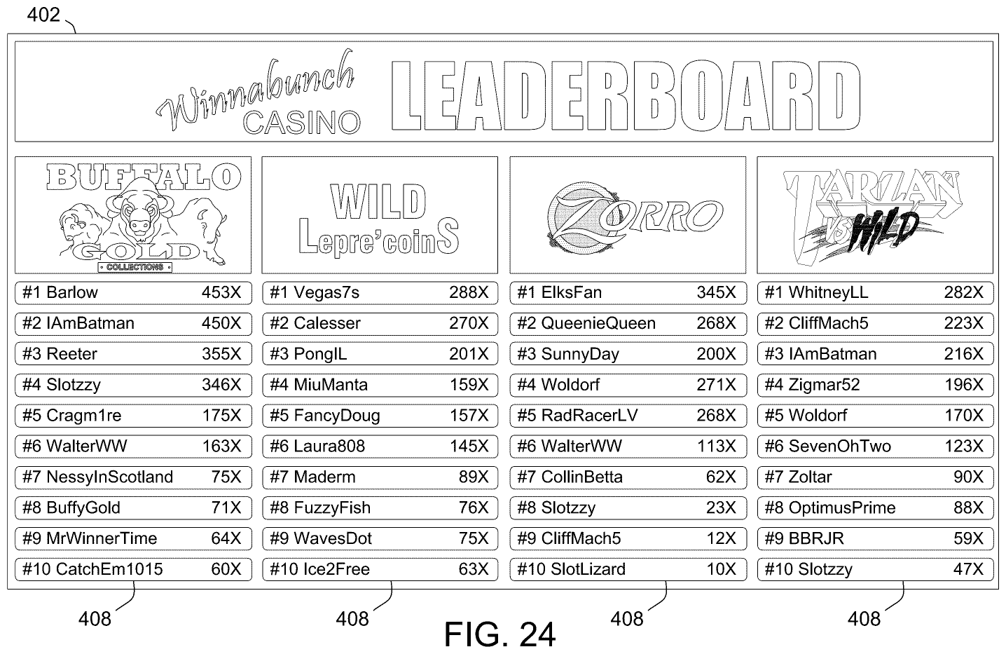

FIG. 24 depicts leaderboard 402 (shown in FIG. 4) including columns 408 corresponding to different games. Leaderboard 402 may be displayed on a monitor in the same area as the associated EGMs 404. In the example shown in FIG. 24, players will make it onto the leaderboard based on a win multiplier achieved through gameplay at EGMs 404. In other embodiments, players may appear on leaderboard based on other parameters, such as those associated with badges 1102 and/or achievements 1402. The same player may appear on multiple leaderboards 402 and/or columns 408, if the player has met the corresponding conditions for appearing on each.

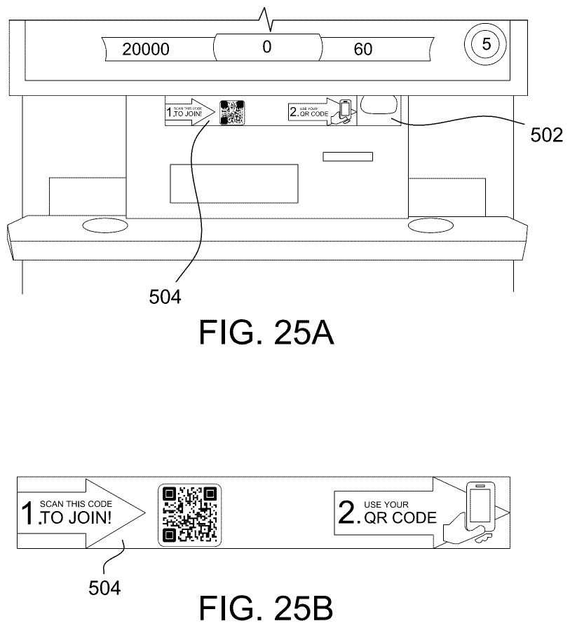

FIG. 25A illustrates QR scanner 502 and sign 504 in further detail, and FIG. 25B illustrates sign 504 in additional detail. Sign 504 may include information letting the player know to use the QR code to find and install app 700 on mobile device 406.

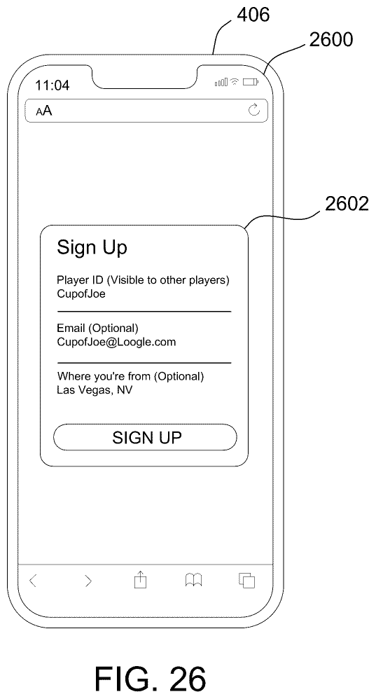

FIG. 26 illustrates a page 2600 that may be displayed by app 700 in response to a player scanning sign 504 with mobile device 406 and downloading and/or accessing app 700 for the first time. Page 2600 may include a sign up field 2602, through which the player may input information to register. Sign up field 2602 may include a field for entering a username, which in some embodiments, may be pre-populated with a randomly selected name from a table of premade names. In some embodiments, sign up field 2602 further includes an email address field and/or a field for the player's location (e.g., where the player is from). In some such embodiments, entering an email address or location may be optional. In some embodiments in which the player provides an email address or other information identifying the player, the email address or other information may be used to link the registration with a pre-existing loyalty account or other user account associated with the player.

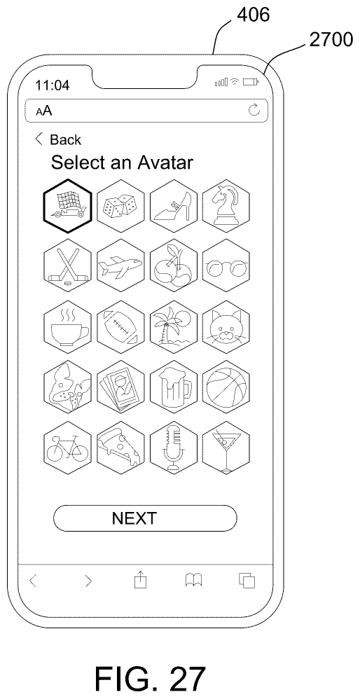

FIG. 27 illustrates a page 2700 that may be displayed by app 700 in response to a player inputting registration information through sign up field 2602. Page 2700 includes pre-created avatars from which the player may select to be associated with the player's account. In some embodiments, players may upload their own avatar, which may be subject to approval by system operators.

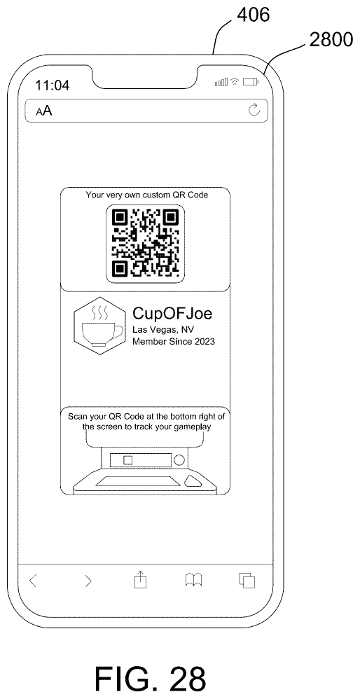

FIG. 28 illustrates a page 2800 that may be displayed by app 700 in response to a player selecting an avatar through page 2700 and/or otherwise navigating to page 2800 using app 700. Page 2800 includes QR code 806, which may be scanned by QR scanner 502 to link mobile device 406 and the associated user account to EGM 404. In some embodiments, QR code 806 may be added to a digital wallet (e.g., Apple Wallet or Google Wallet) of mobile device 406.

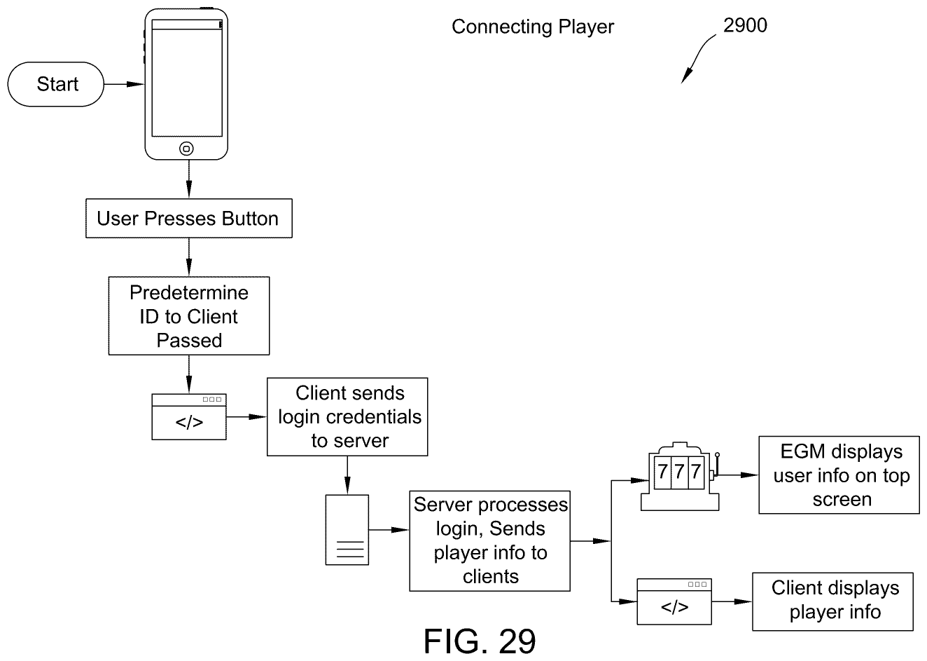

FIG. 29 illustrates a process 2900 for connecting mobile device 406 to EGM 404 using app 700. A player may log into app 700 on mobile device 406, and may input an instruction to connect (e.g., by pressing a button) through app 700. App 700 may then pass input login information to the server, which may processes the login and provide relevant player information to EGM 404 and/or app 700 executing on mobile device 406. EGM 404 and/or mobile device 406 may then display this player information as described above.

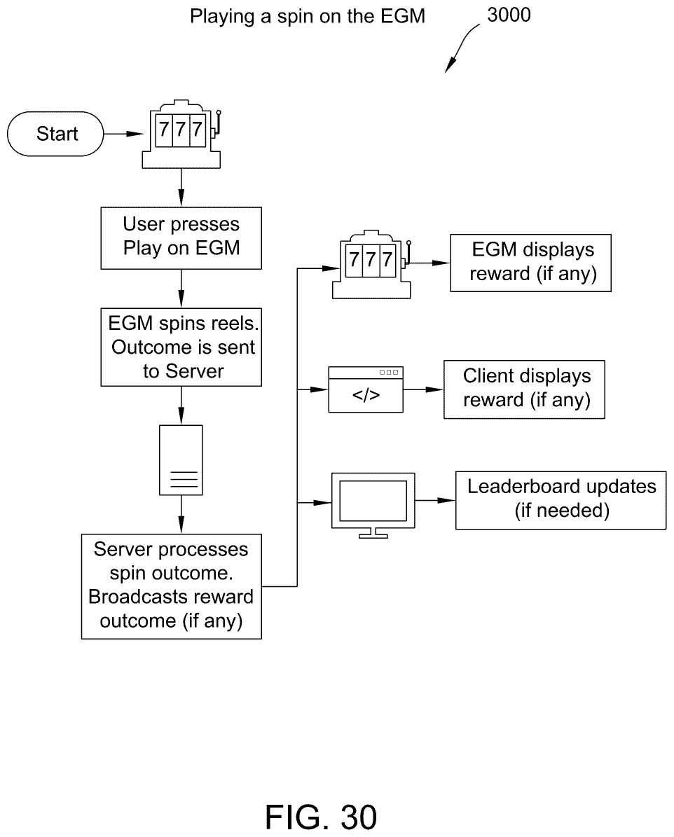

FIG. 30 illustrates a process 3000 for performing a game instance, or “spin” on EGM 404 while connected to mobile device 406. While connected, the player may press a play or spin button, or otherwise initiate a game instance at EGM 404. EGM 404 may provide at least some outcome information to the server. The outcome information may include, for example, a reward, a return on a bet, an indicator of whether or not anything was won, or other such information. In some embodiments, only certain, specific information may be reported by EGM 404, for example, to reduce communication or data processing capacity requirements, to improve information privacy, and/or to meet regulatory requirements. For example, EGM 404 may provide the percentage return on the bet, but not the actual value of credits awarded. The server may process this spin outcome information to determine if any rewards (e.g., badges 1102, achievements 1402, and/or positions on leaderboard 402) are earned, and may then transmit this reward outcome to EGM 404, mobile device 406, and/or leaderboard 402 for display.

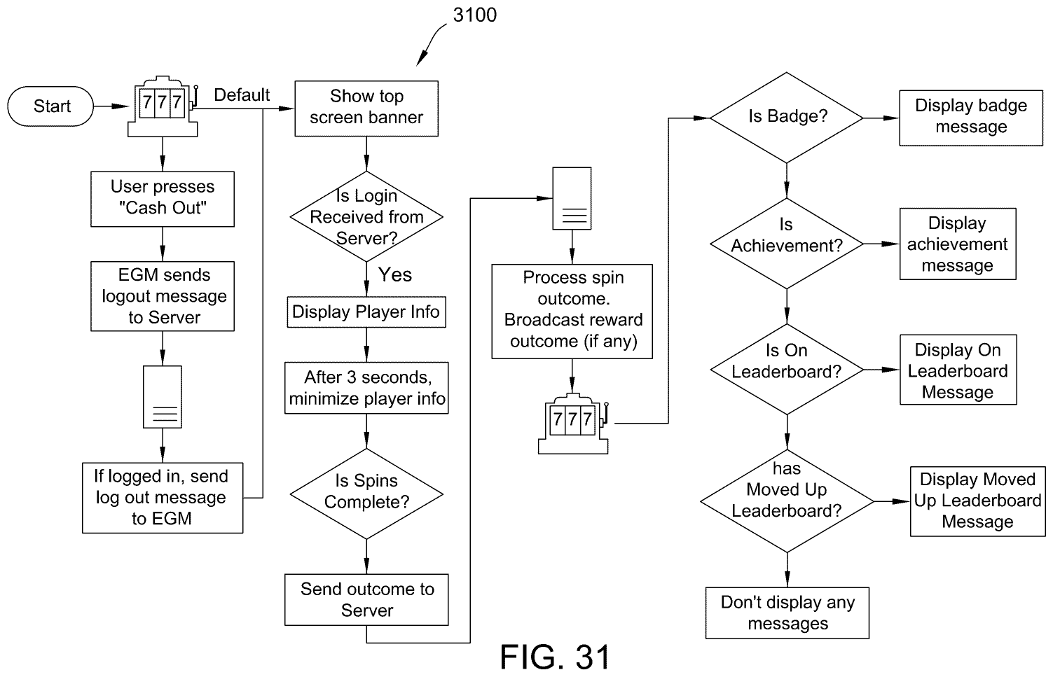

FIG. 31 illustrates a process 3100 for controlling EGM 404. If a logged-in player cashes out, EGM 404 may report this information to the server, which may then send a log out message to EGM 404 instructing EGM 404 to log out the player. If a new login in received, EGM 404 may display player information for a set period of time (as shown in FIGS. 9A and 9B), and after this period (e.g., three seconds), may minimize or show the player information with a lesser profile (as shown in FIGS. 10A and 10B), or alternatively, cease displaying the player information. When a game instance or spin is completed, EGM 404 may transmit spin outcome information, as described above, to the server, which may apply rules to determine a reward outcome (e.g., badges 1102, achievements 1402, earning a position on leaderboard 402, and/or moving up on leaderboard 402). The server may then transmit this rewards outcome information to EGM 404, which may display the awards outcome information (e.g., badges 1102, achievements 1402, and/or a message that a position on leaderboard 402 has been earned or that the player is moving up on leaderboard 402). The rewards outcome information may also be transmitted to mobile device 406 and/or leaderboard 402 for display, as described above.

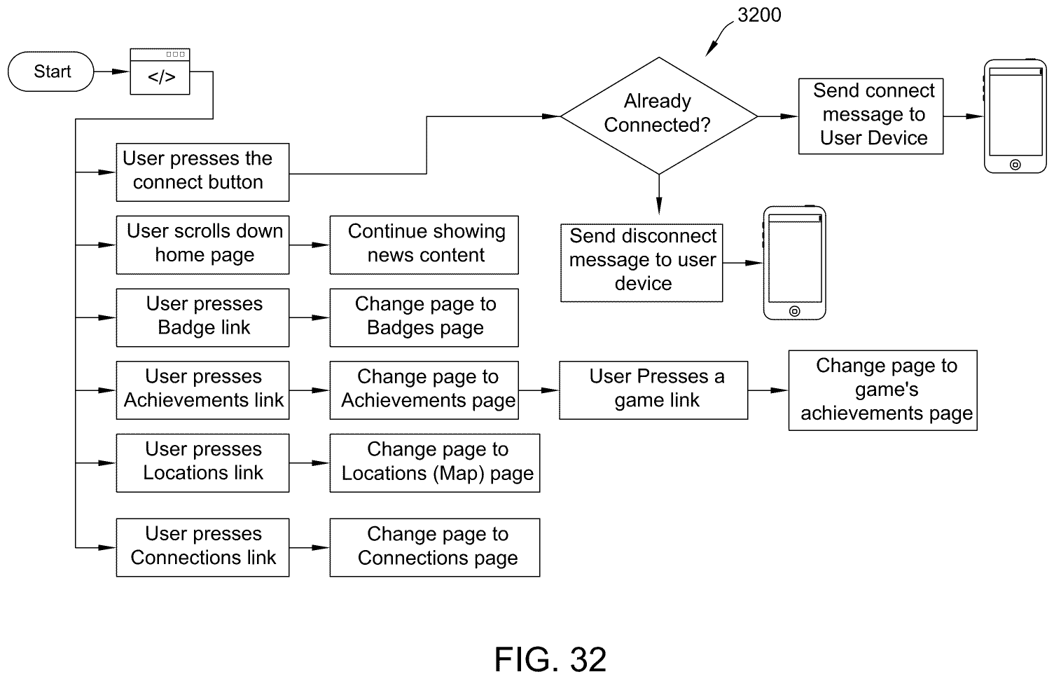

FIG. 32 illustrates a process 3200 for controlling app 700 executed by mobile device 406. If the player attempts to connect, for example, by scanning QR code 806 using QR scanner 502, the server determines whether the player's mobile device 406 is already connected to another EGM 404, and if so, disconnects from the other EGM 404. Mobile device 406 may then be connected to the EGM 404 at which QR code 806 was scanned. If the player scrolls down a home page (e.g., page 800) of app 700, news may be shown. If the player selects the “Badge” link of navigation bar 804, page 2100 indicating which badges 1102 have been earned may be displayed. If the player selects the “Achievements” link of navigation bar 804, page 2200 indicating which achievements 1402 have been earned may be displayed. If the player selects the “Locations” link of navigation bar 804, page 2300 may be displayed. If the user presses a “Connections” link of navigation bar 804, a connections page showing other users who have connected with the player may be shown.

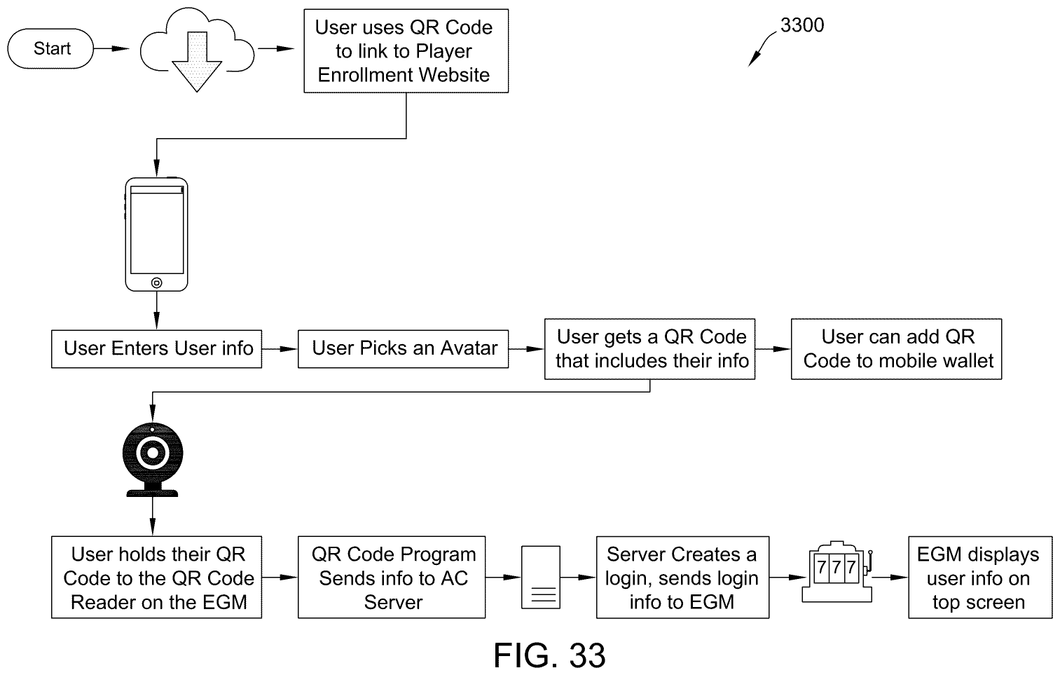

FIG. 33 illustrates a process 3300 for enrolling with app 700 executed by mobile device 406. The player may scan a QR code, such as that included on sign 504, to download app 700 onto mobile device 406. The player may enter user information, for example, into sign up field 2602 of page 2600 shown in FIG. 26. The player may then pick an avatar, for example, from page 2700 shown in FIG. 27. The player may then be assigned a QR code 806, which may be displayed by mobile device 406 in page 2800, as shown in FIG. 28. The player may further add QR code 806 to a mobile wallet of mobile device 406 (e.g., Apple Wallet or Google Wallet). The player may then hold QR code 806 to QR scanner 502 of EGM 404, which may scan QR code 806 and send QR code 806 to the server. The server may identify a login based on QR code 806 and send corresponding login information (e.g., a username, avatar, and/or other identifiers) to EGM 404. EGM 404 may display at least some of this information (e.g., the username and avatar), for example, as shown in FIGS. 9A, 9B, 10A, and 10B.

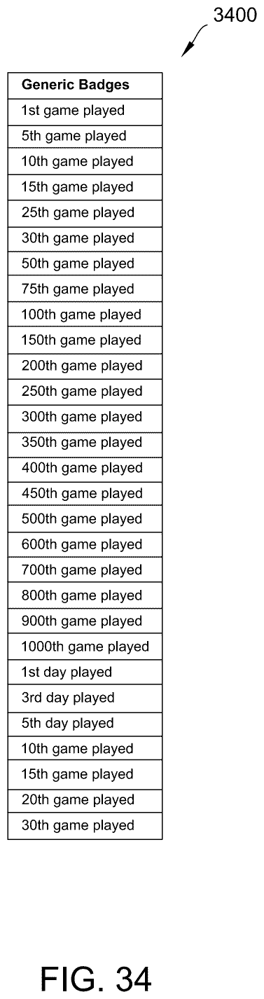

FIG. 34 is a table 3400 illustrating exemplary conditions under which a badge 1102 may be earned by a player.

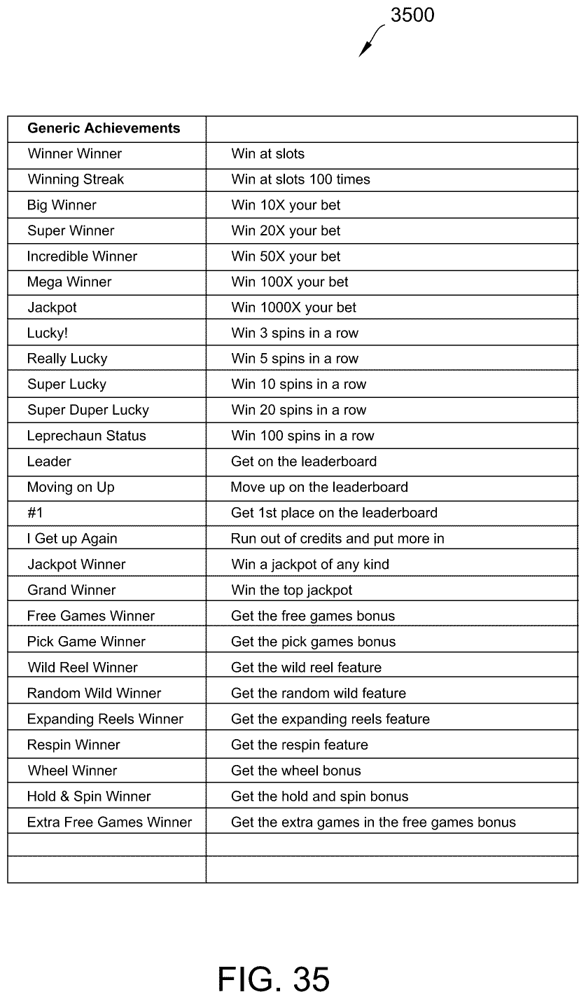

FIG. 35 is a table 3500 illustrating exemplary conditions under which an achievement 1402 may be earned by a player.

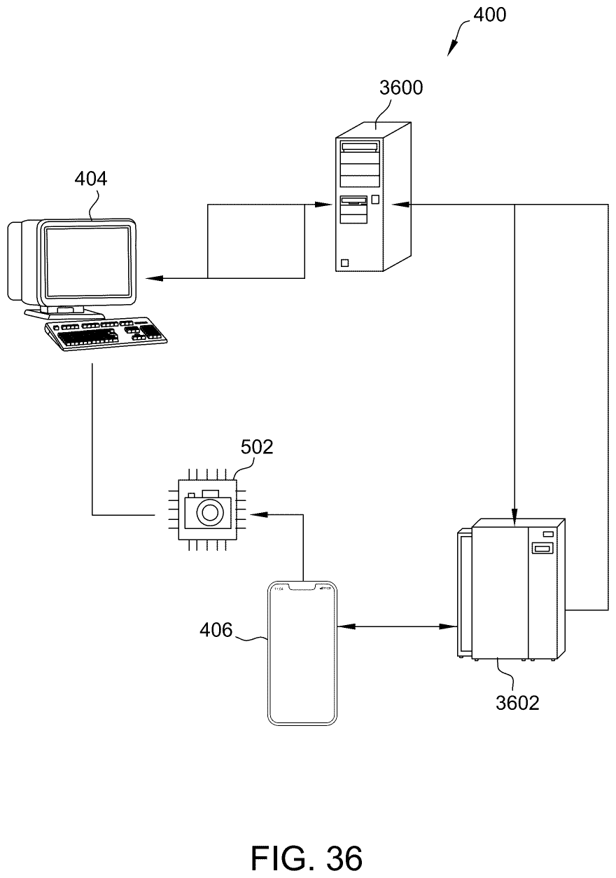

FIG. 36 is a diagram of gaming system 400 (shown in FIG. 4). FIG. 36 illustrates a vertex computing device 3600 configured to communicate with EGM 404, and a mainframe computing device 3602 configured to communicate with vertex computing device 3600 and mobile device 406. Vertex computing device 3600 and/or mainframe computing device 3602 may perform at least some of the server-side functions described herein, such as keeping records of user registrations, logging in users based on information from QR scanner 502, determining whether badges 1102 and/or achievements 1402 have been earned based on gameplay outcome information from EGM 404, and causing EGM 404, mobile device 406, and/or leaderboard 402 to display information such as player information (e.g., username, avatar, and/or notifications of badges 1102, achievements 1104, or leaderboard positions earned).

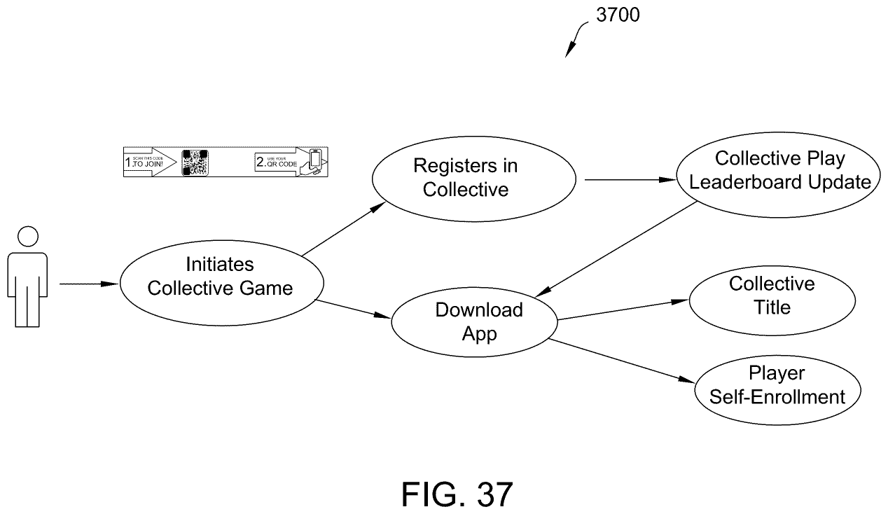

FIG. 37 is a process 3700 for creating a user account using app 700 executing on mobile device 406. If the player has not yet downloaded app 700, the player may scan the QR code on sign 504 to download app 700 on mobile device 406. The player may then input user information, for example, using pages 2700 and 2700 shown in FIGS. 26 and 27. Information input by the player may include, for example, a first name, a last name, an email address, a password, a user name and/or initials, a location, an avatar, whether the player wishes to make their statistics (e.g., earned badges 1102 and/or achievements 1402) visible to other users. In some embodiments, at least some of this information may be optional to enter, while some other information (e.g., a username) may be necessary to enter to create an account. After registering, badges 1102, achievements 1402, or other statistics associated with the player may be visible within app 700 and/or displayed by leaderboard 402 and/or EGM 404, and/or otherwise shared with other users.

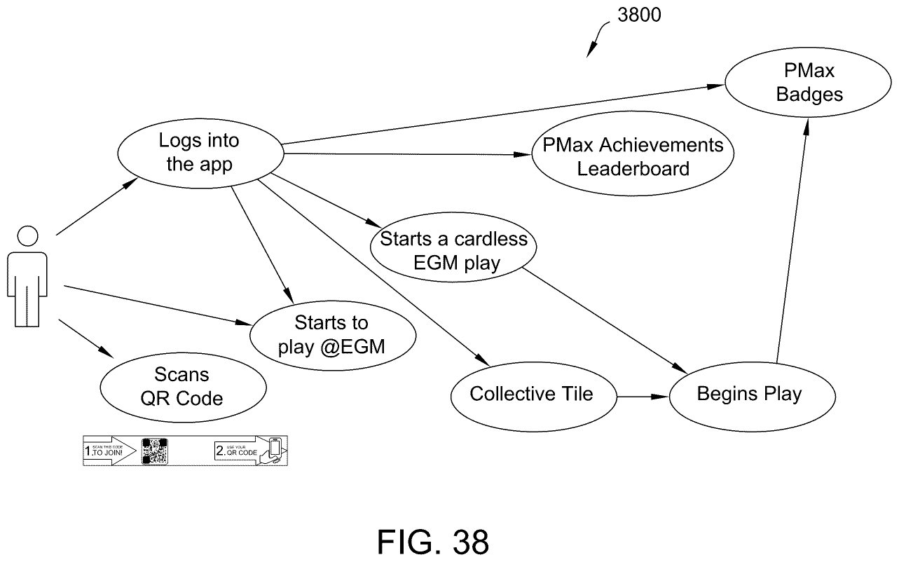

FIG. 38 is a process 3800 for connecting mobile device 406 to EGM 404. If the player has not yet downloaded app 700, the player may scan the QR code on sign 504 to download app 700 on mobile device 406. The player may log into app 700 and scan QR code 806 using QR scanner 502. The player may then initiate play at EGM 404. The player may not necessarily enter a loyalty card or any additional loyalty account information. While playing, the system may determine if any badges 1102 and/or achievements 1402 are earned based upon gameplay at EGM 404, and these badges 1102 and/or achievements 1402 may be displayed by EGM 404 and/or mobile device 406.

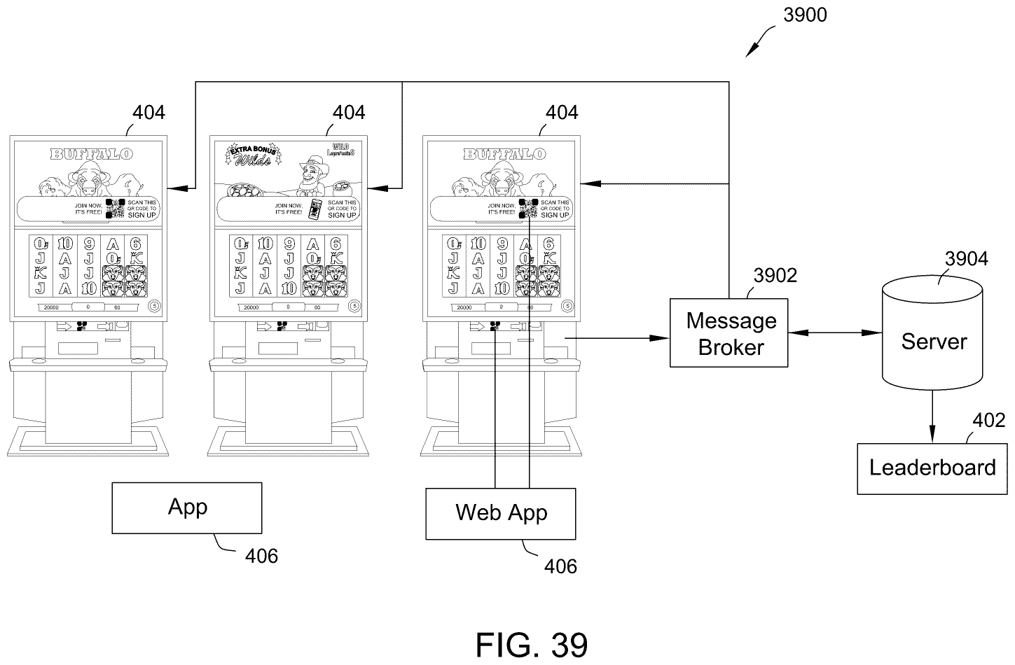

FIG. 39 is a diagram of gaming system 400 (shown in FIG. 4). Gaming system 400 may include a library that the software will use including certain messages that are communicated with the central server and exchanged between the central server and the EGMs 404. All messaging may use message broker 3902. When the player initially scans their QR code 806 at the EGM 404, the login request will be sent from the EGM 404 to a server 3904, then server 3904 will send back the login information (avatar and username) back to the EGM 404. The information shared with the EGM 404 is quasi-anonymous. EGM 404 will display this information to the player on the mobile device 406. From this point on, each time the player spins the reels of the EGM 404 the outcome is sent to server 3904 through message broker 3902, server 3904 will process this information and communicate back to the EGM 404 enabling the rewards system to take to place. In this context, server 3904 will update leaderboards 402 as well based on the information shared with it from the EGM 404 based on the game specific play that is occurring at the EGM 404. Server 3904 is updated with each spin event at the EGM 404. The information being updated at server 3904 includes the wager amount, the total win amount, and other player specific information such as the UUID of the player. An innovative aspect of system 400 is that server 3904 may collect gameplay data and exchange messages with EGMs 404 in a quasi-anonymous manner.

As spin events at the EGM 404 are shared with server 3904, server 3904 may determine if predetermined criteria are met to award a badge 1102 to the player. When the criteria have been met and a badge 1102 and/or achievement 1402 is to be awarded, server 3904 may send this information via a message back to the EGM 404 where the EGM 404 can display the badge 1102 and/or achievement 1402 to the player on screen. The badge/award determination may be made by server 3904 and the image generation assets may be on the EGM 404 via the EGM libraries.

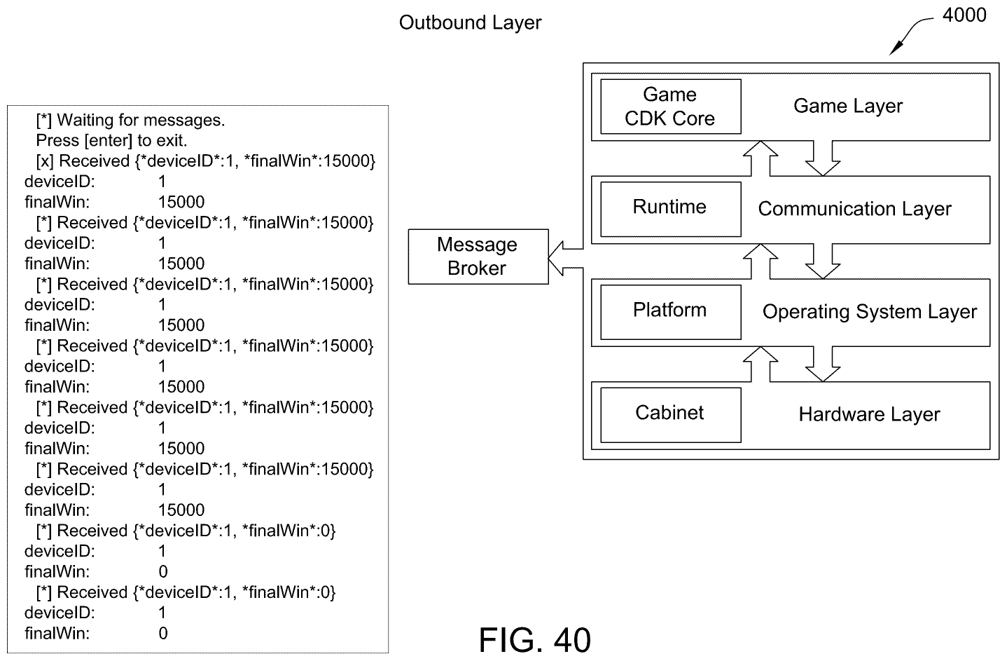

As shown in FIG. 40, when a game is being played at an EGM 404 and the reels are being spun, an RNG determines the locations of the reels, and code at this point may be configured to take the initial wager and win amount and sends it as an outbound message 4000 to the central server 3904. This way a central server can calculate how much the player has won.

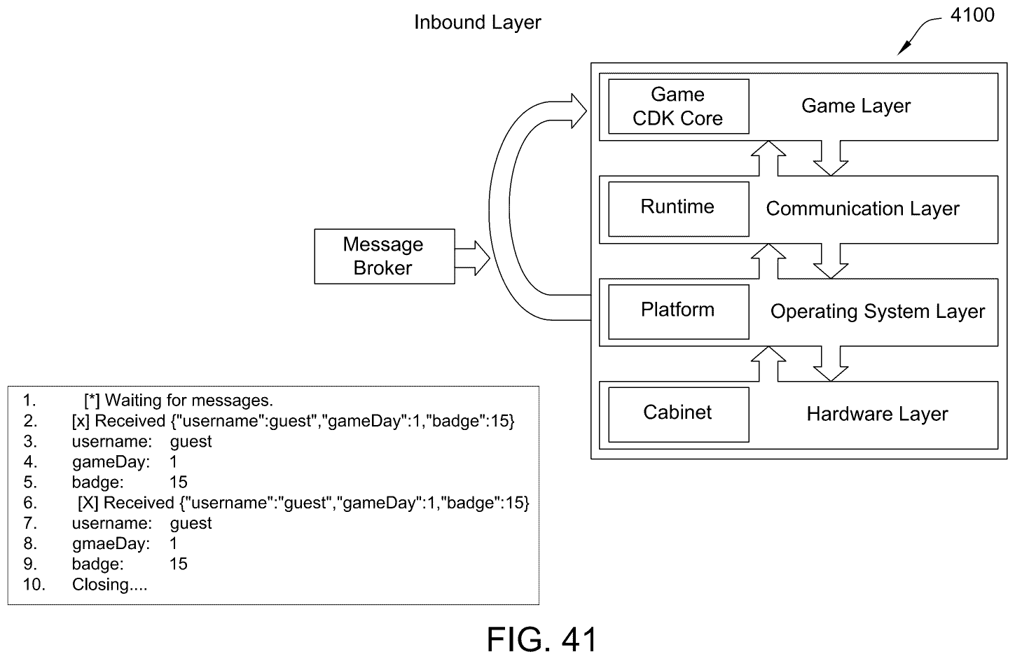

As shown in FIG. 41, when server 3904 sends inbound messages 4100 to the EGM 404, they invoke code that will run through runtime to the game, which may be used to determine how the banner is displayed in the game code after it has been passed through the stack of the game. When an inbound message 4100 is received, a theoretical button may be invoked that transfers to the game to run the code to display the visuals. EGM 404 may capture a log of what has been played and the system may pull where we sent outbound message 4000. Essentially, the system may tap into a messaging system that is already taking place between EGM 404 and the central server. Any information that is exchanged between an EGM 404 and the central server during game play that creates an event can be tapped into which may utilized by server 3904 to make determinations about awarding badges 1102 and/or achievements 1402.

The back-end systems (e.g., server 3904) may be configured to receive messages sent from the EGM code and send messages back to the player engagement platform to populate/display the leaderboard 402. These backend systems are also used to process the QR code 806 at the EGM 404 by sending it to a central server (e.g., server 3904) to identify the player and send the identification back to the EGM to login the player to begin collecting gameplay data.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A player tracking system comprising:
an electronic gaming device including a scanner and a display device;
at least one memory with instructions stored thereon; and
at least one processor in communication with the at least one memory and the electronic gaming device, wherein the instructions, when executed by the at least one processor, cause the at least one processor to:
cause the scanner to read a player code displayed by a mobile device of a player, the mobile device executing a mobile application;
receive gameplay information from the electronic gaming device;
determine whether the read player code is associated with an existing user identifier corresponding to a user account stored in the at least one memory;
if the player code is associated with an existing user identifier, store the received gameplay information in the at least one memory in association with the existing user identifier; and
if the player code is not associated with an existing user identifier, store the received gameplay information in the at least one memory in association with the read player code.

2. The player tracking system of claim 1, wherein the instructions further cause the at least one processor to:
when the read player code is not associated with a user identifier, cause the mobile device executing the mobile application to prompt the player to input player information; and
in response to an input of the player information by the player, generate a first user account based on the input player information, the first user account associated with the player, the player code, and a first user identifier.

3. The player tracking system of claim 2, wherein the instructions further cause the at least one processor to, in response to generating the first user account, store the received gameplay information in the at least one memory in association with the first user identifier.

4. The player tracking system of claim 2, wherein the instructions further cause the at least one processor to:
in response to generating the first user account, perform a lookup to identify previous gameplay information associated with the read player code; and
store the identified previous gameplay information in association with the first user identifier.

5. The player tracking system of claim 1, wherein the instructions further cause the at least one processor to cause the display device of the electronic gaming device to display a user identifier associated with the read player code.

6. The player tracking system of claim 1, further comprising at least one leaderboard display, wherein the instructions further cause the at least one processor to:
generate a leaderboard based on gameplay information associated with a plurality of user identifiers stored in the memory and one or more leaderboard parameters, the generated leaderboard including one or more qualifying user identifiers that qualify for the leaderboard based on the one or more leaderboard parameters; and
cause the at least one leaderboard display to display the generated leaderboard.

7. The player tracking system of claim 6, wherein the instructions further cause the at least one processor to:
for each qualifying user identifier, identify at least one of an associated mobile device or an associated electronic gaming machine that is associated with the qualifying user identifier; and
cause the at least one of the associated mobile device or the associated electronic gaming machine to display a message indicating that a spot on the leaderboard has been earned.

8. The player tracking system of claim 1, wherein the instructions further cause the processor to:
determine a user identifier qualifies for a badge based on gameplay information associated with the user identifier and one or more badge parameters; and
cause an associated mobile device that is associated with the user identifier qualifying for the badge to display the badge.

9. The player tracking system of claim 1, wherein the scanner is a quick response (QR) scanner and the read player code is a QR code.

10. The player tracking system of claim 1, wherein the electronic gaming device displays a code that, when scanned by the mobile device, causes the mobile device to prompt the player to install the mobile application.

11. A method for user tracking in electronic gaming, the method performed by at least one processor in communication with the at least one memory and an electronic gaming device including a scanner and a display device, the method including:
causing the scanner to read a player code displayed by a mobile device of a player, the mobile device executing a mobile application;
receiving gameplay information from the electronic gaming device;
determining whether the read player code is associated with an existing user identifier corresponding to a user account stored in the at least one memory;
if the player code is associated with an existing user identifier, storing the received gameplay information in the at least one memory in association with the existing user identifier; and
if the player code is not associated with an existing user identifier, storing the received gameplay information in the at least one memory in association with the read player code.

12. The method of claim 11, further comprising
when the read player code is not associated with a user identifier, causing the mobile device executing the mobile application to prompt the player to input player information; and
in response to an input of the player information by the player, generating a first user account based on the input player information, the first user account associated with the player, the player code, and a first user identifier.

13. The method of claim 12, further comprising, in response to generating the first user account, storing the received gameplay information in the at least one memory in association with the first user identifier.

14. The method of claim 12, further comprising:
in response to generating the first user account, performing a lookup to identify previous gameplay information associated with the read player code; and
storing the identified previous gameplay information in association with the first user identifier.

15. The method of claim 11, further comprising causing the display device of the electronic gaming device to display a user identifier associated with the read player code.

16. The method of claim 11, further comprising:
generating a leaderboard based on gameplay information associated with a plurality of user identifiers stored in the memory and one or more leaderboard parameters, the generated leaderboard including one or more qualifying user identifiers that qualify for the leaderboard based on the one or more leaderboard parameters; and
causing at least one leaderboard display to display the generated leaderboard.

17. The method of claim 16, further comprising:
for each qualifying user identifier, identifying at least one of an associated mobile device or an associated electronic gaming machine that is associated with the qualifying user identifier; and
causing the at least one of the associated mobile device or the associated electronic gaming machine to display a message indicating that a spot on the leaderboard has been earned.

18. The method of claim 11, further comprising:
determining a user identifier qualifies for a badge based on gameplay information associated with the user identifier and one or more badge parameters; and
causing an associated mobile device that is associated with the user identifier qualifying for the badge to display the badge.

19. The method of claim 11, wherein the scanner is a quick response (QR) scanner and the read player code is a QR code.

20. At least one non-transitory computer-readable storage media having instructions embodied thereon, wherein when executed by at least one processor in communication with the at least one memory and an electronic gaming device including a scanner and a display device, the instructions cause the at least one processor to:
cause the scanner to read a player code displayed by a mobile device of a player, the mobile device executing a mobile application;
receive gameplay information from the electronic gaming device;
determine whether the read player code is associated with an existing user identifier corresponding to a user account stored in the at least one memory;
if the player code is associated with an existing user identifier, store the received gameplay information in the at least one memory in association with the existing user identifier; and
if the player code is not associated with an existing user identifier, store the received gameplay information in the at least one memory in association with the read player code.
